(19) United States
(12) Patent Application Publication
(10) Pub. No.: US 2008/0094210 A1
(43) Pub. Date: Apr. 24, 2008

(54) Platform for Ubiquitous Sensor Deployment in Occupational and Domestic Environments

(75) Inventors: Joseph A. Paradiso, Medford, MA (US); Joshua Lifton, Cambridge, MA (US); Mark Feldmeier, Waukesha, WI (US); Yasuhiro Ono, Saitama-city (JP)

Correspondence Address: NORMA E HENDERSON;HENDERSON PATENT LAW, 13 JEFFERSON DR, LONDONDERRY, NH, 03053, US

(73) Assignee: MASSACHUSETTS INSTITUTE OF TECHNOLOGY, Cambridge, MA (US)

(21) Appl. No.: 11/874,198

(22) Filed: Oct. 17, 2007

Related U.S. Application Data
(60) Provisional application No. 60/852,481, filed on Oct. 17, 2006.

(51) Int. Cl. G08B 21/00

(52) U.S. Cl. 340/540

(57) ABSTRACT

A multimodal sensor network node is integrated into a power strip. A sensor platform comprises a power outlet, typically in the form of a power strip, at least one environmental sensor integrated into the power strip, and at least one transceiver for communicating data measured by the sensor. A sensor network is made up of a group of sensor platforms. The platforms may include a controller for directing measurement and communication of data by the sensors, and may communicate through wireless or wired communication. The device has access to power through its line cord, can control and measure the current profile consumed by devices plugged into its outlets and control the voltage at each outlet independently, supports an ensemble of sensors, and can connect to other devices. Typically, microphone, light, temperature, and vibration sensors are intrinsically built into the device, while other sensor types can be added easily.

### RELATED APPLICATIONS

This application claims the benefit of U.S. Provisional Application Ser. No. 60/852,481, filed Oct. 17, 2006, the entire disclosure of which is herein incorporated by reference.

### FIELD OF THE TECHNOLOGY

The present invention relates to environmentally-deployed sensor networks and, in particular, to use of electrical outlets as platforms for sensor network nodes.

### BACKGROUND

Most, if not all, sensor network platforms in use today are characterized by an emphasis on a low-power, unobtrusive, versatile design and an understanding, implicit or otherwise, that a network's sensor nodes are to be handled only briefly, if at all, by expert researchers between long periods of unattended operation. Although this paradigm has generally served the research community well and fits many application scenarios, it precludes a full exploration of the sensor network application space. In particular, this paradigm is not fully appropriate for ubiquitous computing settings. In fact, the commonly cited vision of living in a truly aware environment, one which senses and can respond to every action, does not necessarily imply that the sensor nodes upon which this vision is built need be low-power, unobtrusive, or versatile.

The notion that a sensor network encompasses many different instantiations is well documented. The current formulation of a sensor network is less than 10 years old [D. Estrin, R. Govindan, J. S. Heidemann, and S. Kumar, “Next century challenges: Scalable coordination in sensor networks”, Mobile Computing and Networking, pages 263-270, 1999], whereas the term “sensor network” has been in use for at least 30 years [Distributed sensor networks, Carnegie-Mellon, University workshop proceedings, December 1978], and has come to encompass everything from hopping land mines [W. M. Merrill, L. Girod, B. Schi.er, D. McIntire, G. Rava, K. Sohrabi, F. Newberg, J. Elson, and W. Kaiser, “Dynamic networking and smart sensing enable next-generation landmines”, IEEE Pervasive Computing Magazine, pages 82-89, October December 2004] to artificial sensate skins [J. Paradiso, J. Lifton, and M. Broxton, “Sensate Media—Multimodal Electronic Skins as Dense Sensor Networks”, BT Technology Journal, 22(4):32-44, October 2004].

Studying the power consumption of various electrical devices has a rich history. Such information can be used to identify classes of devices [C. Laughman, K. Lee, R. Cox, S. Shaw, S. Leeb, L. Norford, and P. Armstrong, “Power signature analysis”, IEEE Power & Energy Magazine, March-April 2003; W. Lee, G. Fung, H. Lam, F. Chan, and M. Lucente, “Exploration on load signatures”, Proceedings of the International Conference on Electrical Engineering (ICEE), 2004], individual devices [M. Ito, R. Uda, S. Ichimura, K. Tago, T. Hoshi, and Y. Matsushita, “A method of appliance detection based on features of power waveform”, Proceedings of the International Symposium on Applications and the Internet, pages 291-294, 2004], detect and predict electrical and mechanical faults in motors [M. E. H. Benbouzid, “A review of induction motors signature analysis as a medium for faults detection”, IEEE Transactions on Industrial Electronics, 47(5), October 2000], monitor energy costs and consumption [L. Norford, S. Leeb, D. Luo, and S. Shaw, “Advanced electrical load monitoring: A wealth of information at low cost”, MIT technical report], and as a form of surveillance [G. W. Hart, “Residential energy monitoring and computerized surveillance via utility power flows”, IEEE Technology and Society Magazine, June 1989].

The SeeGreen system uses power line communication to monitor and control metering devices attached to electrical appliances, but does not extend to other sensing modalities or communication channels [J. D. Kaufman, “Seegreen: A tool for real-time distributed monitoring of home electricity consumption”, Master's thesis, MIT Media Lab, May 2001]. The “Kill A Watt” by P3 International is a commercially available surrogate electrical outlet for home energy consumption monitoring, displaying volts, amps, watts, Hz, and VA for a single electrical outlet. A Spy Labs product makes evident the privacy concerns related to embedding sensing capabilities into commonplace objects. The AGS-01 is a power strip with built-in GSM cell phone transmitter which can be used to monitor surrounding audio from anywhere in the world simply by phoning the number of the inserted SIM card [Spy Labs. AGS-01: GSM Transmitter Concealed in a Surge Protector]. At another extreme, Chip PC Technologies' Jack PC product is a fully functional thin client computer designed to fit into a standard LAN wall socket with a monitor, mouse, and keyboard plugging directly into the wall.

Power strips themselves are evolving in form and function. It is common now to see them augmented with surge protectors, noise filters, and pass-through connectors for data, cable TV, and phone lines, and designers are looking at radically new packaging to improve usability, such making the physical form factor reconfigurable and the plugged-in power cords more easily differentiable [Product Design Forums. Swivel socket-dynamic surge protector. December 2005]. Intel Research and USC/ISI built and deployed a conference room monitoring and reservation system using a sensor network [W. S. Conner, J. Heidemann, L. Krishnamurthy, X. Wang, and M. Yarvis. Workplace applications of sensor networks. Technical Report USC/ISI Technical Report ISI-TR-2004-591, Intel Research and Development and University of Southern California, Information Sciences Institute, 2004]. This system is notable because it involved a real-world sensor network application within a workplace environment and it demonstrated how existing infrastructure, in this case motion detectors for turning on and off lights, can be leveraged by the sensor network.

In his article introducing the concept of ubiquitous computing, Mark Weiser gives the electric motor as an example of how technology can disappear into the background [M. Weiser, “The computer for the 21st century”, Scientific American, 265(3):94-104, 1991]. Taking this example further, when electricity production first began, the thought that it would be available from holes spaced every couple of meters in every wall in every house was looked upon as absurd and highly impractical. This example illustrates a likely evolution of sensor networks, which must achieve exactly this scale of infrastructure if they are to leave the research lab. As the cost of sensors decreases, it will therefore not be unusual to see them incorporated into devices that are mainly intended for other purposes, in order to widen their domain of application.

### SUMMARY

The present invention integrates a multimodal sensor network node into a power strip. In a preferred embodiment, the device has access to power, and potentially to networking, through its line cord, can control and measure the detailed current profile consumed by devices plugged into its outlets, in addition to controlling the voltage at each outlet independently, supports an ensemble of sensors, and hosts an RF network that can connect to other sensors and other nearby wireless sensors, effectively acting as a sensor network base station. In a preferred embodiment, microphone, light, temperature, and inertial vibration sensors are intrinsically built into the device, while other sensors such as thermal motion detectors and cameras can be added easily.

In one aspect, the present invention is a sensor platform comprising a power outlet, typically in the form of a power strip, at least one environmental sensor integrated into the power strip, and at least one transceiver for communicating data measured by the sensor to a remote receiving unit. In another aspect, the present invention is a sensor network made up of a group of such sensor platforms. The platforms may include a controller for directing measurement and communication of data by the sensors, and may communicate through either wireless or wired communication.

### BRIEF DESCRIPTION OF THE DRAWINGS

Other aspects, advantages and novel features of the invention will become more apparent from the following detailed description of the invention when considered in conjunction with the accompanying drawings wherein:

FIG. 1 is an embodiment of a Plug sensor node according to the present invention;

FIGS. 2A-B depict an embodiment of a Plug expansion port schematic pin out according to one aspect of the present invention;

FIGS. 3A-E are a schematic of an embodiment of data log expansion circuit board for the Plug device, according to another aspect of the present invention;

FIGS. 4A-D are a schematic of an embodiment of a Lug, a small wireless, battery-powered device that interfaces with the Plug device, according to another aspect of the present invention;

FIG. 5 is example data taken from a single Plug during a rudimentary scenario, according to an aspect of the present invention;

FIG. 6 is example data obtained using a prototype embodiment of a Plug device according to the present invention;

FIG. 7 depicts plots of current versus time taken from a Plug sensor node for a variety of common electronic devices;

FIG. 8 is a schematic of the physical layout of an experimental implementation of a Plug sensor network;

FIG. 9 depicts experimental results obtained over time from three specific Plugs during the experimental data collection period using the experimental implementation of FIG. 8;

FIGS. 10A-H are a schematic of an exemplary embodiment of a low voltage Plug board according to the present invention;

FIGS. 11A-E are a schematic of an exemplary embodiment of a high voltage Plug board according to the present invention;

FIG. 12 is a schematic of an exemplary embodiment of a radio circuit board for a Plug according to an aspect of the present invention; and

FIG. 13 is an overview of the functional structure of an embodiment of the Plug firmware according to an aspect of the present invention.

### DETAILED DESCRIPTION

The present invention integrates a sensor node of the kind seen commonly in wireless sensor networks into a power strip, such as is commonly found in homes and offices. This can have many advantages, not the least of which are the easy availability of power and ubiquitous deployment. Accordingly, the present invention embeds a multimodal sensor network node into a common power strip. This device has access to power, and potentially to networking, through its line cord, can control and measure the detailed current profile consumed by devices plugged into its outlets, in addition to controlling the voltage at each outlet independently, supports an ensemble of sensors, and optionally hosts an RF network that can connect to other sensors and other nearby wireless sensors, effectively acting as a sensor network base station. In a preferred embodiment, microphone, light, temperature, and inertial vibration sensors are intrinsically built into the device, while other sensors such as thermal motion detectors and cameras can be added easily. The present invention may be employed in a host of ubiquitous computing applications and a variety of navigation representation paradigms for sensor network data can be developed on these devices when they are massively deployed.

The “Plug”, as it is commonly referred to, is a sensor node modeled on a common electrical power outlet strip and designed specifically for ubiquitous computing environments. As with most sensor nodes, each Plug has its own micro-controller for tending to a host of sensors, actuators, and wireless and wired communication interfaces. In addition, a Plug node can serve as a normal power strip, providing multiple standard three-prong U.S. electrical outlets. As such, a Plug node must be plugged into a power outlet in order to operate, making the issue of extreme energy conservation, such as is required for long-term battery-powered deployments, nearly irrelevant. Furthermore, considering a typical Plug node's comparatively large size (approximately 20 cm×7 cm×12 cm) and weight (approximately 1 kg), it is difficult to argue that a Plug is unobtrusive based on its physical specifications alone.

Nonetheless, within the context of ubiquitous computing, a network of Plug nodes is ideally suited for sensor network research and applications. By their nature, ubiquitous computing scenarios take place in environments normally inhabited by people, of which the home and the workplace are the dominant examples. Both these settings are infused with ample electrical power, typically in the form of wall sockets spaced every two or three meters. Thus, the need for exceptionally low-power sensor nodes is mitigated so long as the nodes need not be mobile. Similarly, what is considered unobtrusive depends on the setting. Power strips are common in nearly every home and workplace setting. A cursory examination of one of the typical 14-square meter offices used by three graduate students revealed no less than 10 power strips, not including wall outlets. Despite this pervasiveness, most of the time, power strips go nearly unnoticed. A true metric of a sensor node's obtrusiveness must take into account how well it blends with its environment, not just its physical size and weight.

The versatility of a Plug node is somewhat two-sided. For example, like other versatile sensor network platforms, Plug nodes are richly multi-modal, with multiple sensor channels, and can be expanded upon with a generic digital and analog expansion port. Unlike many other platforms, the Plug node's physical form factor and deployment scenarios are rather limited. However, although the mechanics of how a Plug node is actually used are very narrowly defined (i.e., electrical devices may be plugged into it), the uses such mechanics afford are only limited by the uses of electrically powered devices. A Plug is versatile in the same sense modern electrical infrastructure is versatile. Moreover, a Plug node's power switching capabilities and built-in speaker give it significant actuation advantages over most other sensor network platforms, which typically require hardware extensions to enable actuation.

The crux of the Plug's utility as a sensor network platform lies in part in the tight integration of the observed and the observer. That is, a primary purpose of a Plug is to measure how it is being used or to ascertain context relating to its immediate neighborhood. The fact Plug nodes have a well-defined use at all is unusual in itself and contrasts sharply with most sensor network nodes, which are largely designed to be hidden throughout an environment and not interacted with directly. The Plug platform may be the first to attract the very phenomena it is meant to sense. This principle of designing sensor networks as integral parts of their environments, as opposed to additions layered on top thereof, is central to the Plug platform and will likely play a major role in bringing sensor networks out of the research lab into the real world. Intelligently augmenting commonplace devices already used for dedicated applications is a clear path toward ubiquitous sensing, as the cost of adding sensing, networking, and computing capabilities to individual devices is relatively low and even a single device has utility, allowing the cost of the entire network to be spread over time.

The Plug sensor network is therefore a ubiquitous networked sensing platform ideally suited to broad deployment in environments where people work and live. The backbone of the prototype Plug sensor network is a set of 35 sensor-, radio-, and computation-enabled power strips distributed throughout the third floor of the MIT Media Lab. A single Plug device fulfills all the functional requirements of a normal power strip (i.e., four 120V, 60 Hz electrical outlets; surge protector circuit; standard electrical connector to a US-style wall socket), and can be used without special training. Additionally, each Plug has a wide range of sensing modalities (e.g., sound, light, electrical current and voltage, vibration, motion, and temperature) for gathering data about how it is being used and its nearby environment. The Plug sensor network is the first to embody the idea of designing sensor nodes to seamlessly become a part of their environment.

As opposed to deploying battery-powered sensor nodes into an environment, which would need to be laboriously supported (e.g., batteries need to be periodically replaced), the Plug system has access to AC power, as it is a power strip, and hence the sensor node can tap power directly from the AC line, needing no battery. Since power strips are ubiquitous in offices and often in homes, they are common items in everyday use, and therefore already have heavy penetration. Since people have a use for power strips, they will keep them in their spaces, hence these devices have intrinsic basic appeal, as they perform a useful base function. The sensor node can be thought of as being a “wart” on the back of a power strip upon functional design, not necessarily impacting the basic design of a power strip in an extreme way.

The Plug platform augments the utility of a standard power strip with sensing, communication, and computational abilities to effect a sensor node for active use in domestic and occupational settings while at the same time forming the backbone of a ubiquitous computing environment. To these ends, each Plug offers four standard US electrical outlets supplying 120VAC at 60 Hz. High turn ratio transformers sense the current drawn from each outlet and triacs allow power to be quickly switched on or off on each outlet. A varistor provides protection against electrical surges. The four current sensors and four switches are monitored and controlled by an Atmel AT91SAM7S64, a peripheral-rich microprocessor based on the 32-bit ARM7 core running at 48 MHz with 16 KB of SRAM and 64 KB of internal flash memory. The same microprocessor controls all other aspects of the Plug as well, including two LEDs, a push button, a small speaker, a piezoelectric cantilever vibration sensor, a microphone, a phototransistor, a 2.4 GHz ChipCon CC2500 wireless transceiver, a voltage sensor, a USB 2.0 port, and an extensive expansion port for adding custom hardware to the Plug. The voltage sensor has a dynamic range of ±280V relative to the neutral line and the current sensors have a dynamic range of ±4.1 A, but can withstand up to 30 A. An analog volume knob ensures that the speaker can be manually deactivated.

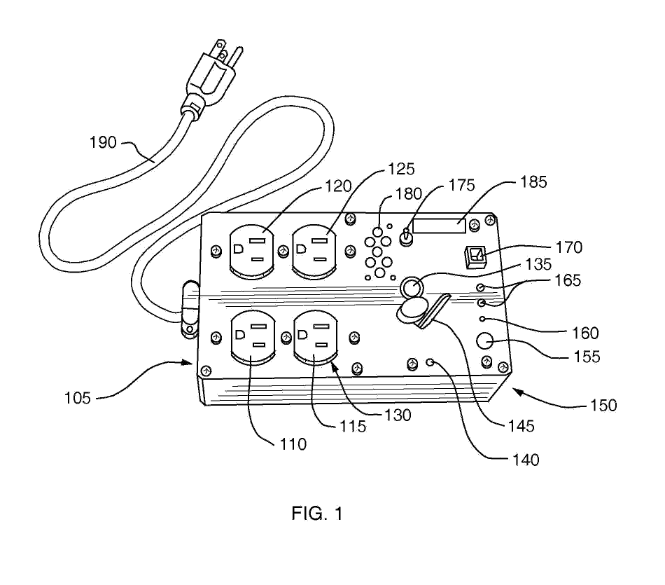

FIG. 1 is an embodiment of a Plug sensor node. FIG. 1 depicts microcontroller 105 (48 MHz, 32-bit, 64 KB flash, 16 KB SRAM), four independent outlets 110, 115, 120, 125 with current sensors and digitally-controlled switches, input voltage sensor and over-voltage protection 130, JTAG debugging and programming interface 135, light sensor 140, wireless transceiver 145 (2.4 GHz 500 kbps), vibration detector 150, microphone 155, control button 160, LED indicators 165, USB 2.0 port 170, volume control 175, 1.5 W speaker 180, and expansion port 185 (SPI, analog-to-digital, PWM, GPIO, etc.). Power line 190 provides energy and communications. The device may be employed to monitor current profiles and switch individual sockets. It hosts basic sensors (e.g. microphone, light, motion) and may include an expansion port for others. It also may act as a hub for a wireless sensor network. The embodiment of FIG. 1 was designed to be amenable to construction by students, and hence is somewhat bulky. The industrial design miniaturizes the sensor node component and appears more like a conventional power strip.

While a specific configuration of the Plug is described herein, it will be clear to a person having ordinary skill in the art that many other devices and configurations are suitable and may be advantageously employed in the present invention. In addition, in an alternate embodiment, the present invention can take the form of modules that plug into a single outlet, optionally with outlets of their own, so they are more of an outlet “cover” or “wart” rather than a power strip. These provide sensor nodes that plug in and incorporate network functionality as a key part of the system.

At present, the 20-pin expansion port houses a module with a passive infrared (PIR) sensor for detecting motion, an SD memory card slot for removable data logging, a 4 Mbit external flash memory for storing persistent state (e.g., calibration constants and unique identifiers), and a digital 13 bit temperature sensor. A separate breadboard expansion module allows for quick prototyping. The pins of the expansion port can be variously multiplexed by the Plug's internal microcontroller to provide up to 17 general purpose digital input/output (GPIO) pins with interrupts, Universal Synchronous Asynchronous Receive Transmit (USART), two wire interface (TWI), serial peripheral interface (SPI) with two chip selects, one fast interrupt, one analog to digital converter channel, and electrical ground. Of the GPIO pins, three can continuously source up to 16 mA and the others can source up to 5 mA, so long as the total current sourced is less than 150 mA. Of course, an expansion module can also plug in directly to one of the Plug's electrical outlets if it needs more energy.

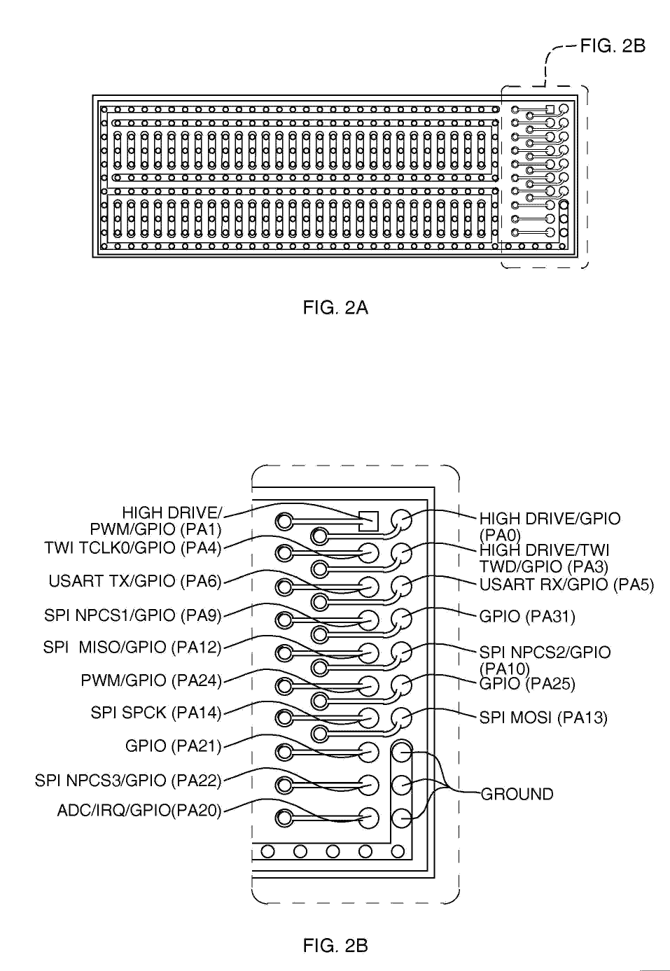

A breadboard expansion module allows for quick prototyping. Another imbues the Plug with the ability to uniquely identify the devices Plugged into it using an RFID reader. The pins of the expansion port can be variously multiplexed by the Plug's internal microcontroller to provide up to 17 general purpose digital input/output (GPIO) pins with interrupts, Universal Synchronous Asynchronous Receive Transmit (USART), two wire interface (TWI), serial peripheral interface (SPI) with two chip selects, one fast interrupt, one analog to digital converter channel, and electrical ground. Of the GPIO pins, three can continuously source up to 16 mA and the others can source up to 5 mA, so long as the total current sourced is less than 150 mA. Of course, an expansion module can also plug in directly to one of the Plug's electrical outlets if it needs more energy. FIGS. 2A-B depict an embodiment of a Plug node expansion port schematic pin out according to one aspect of the present invention.

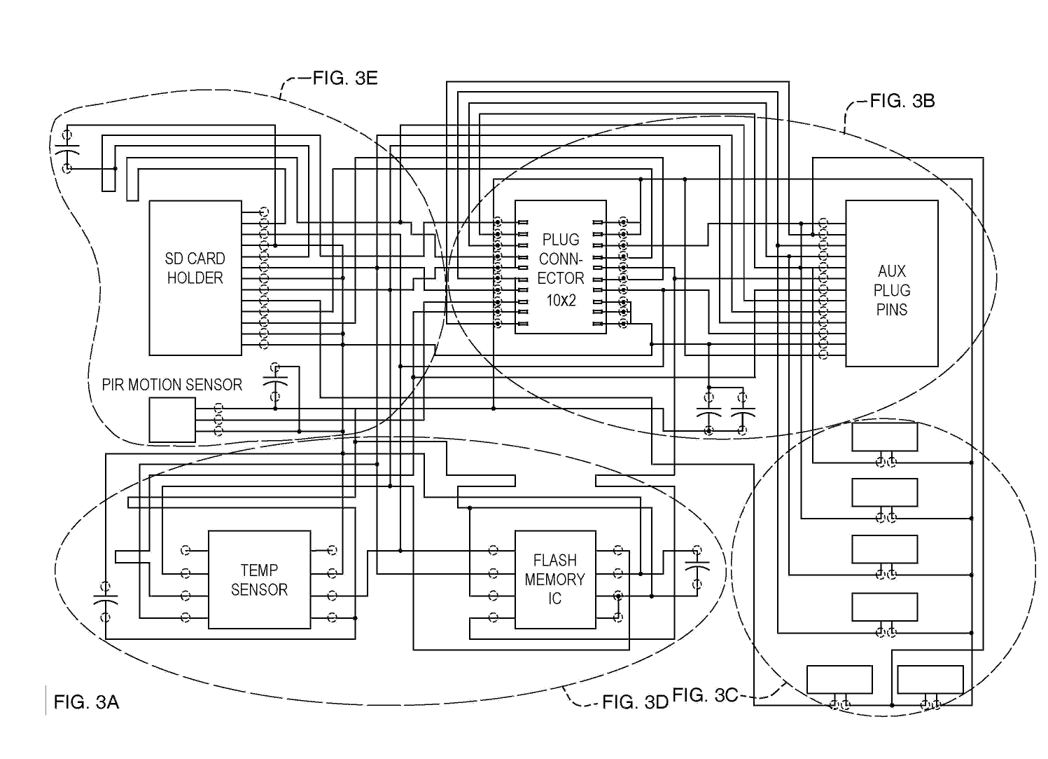

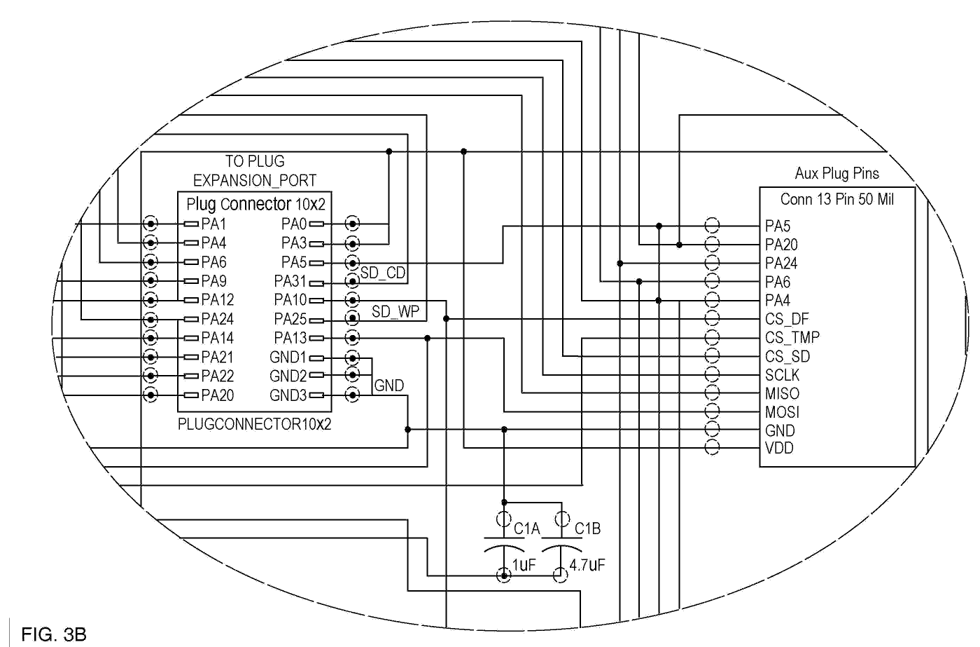

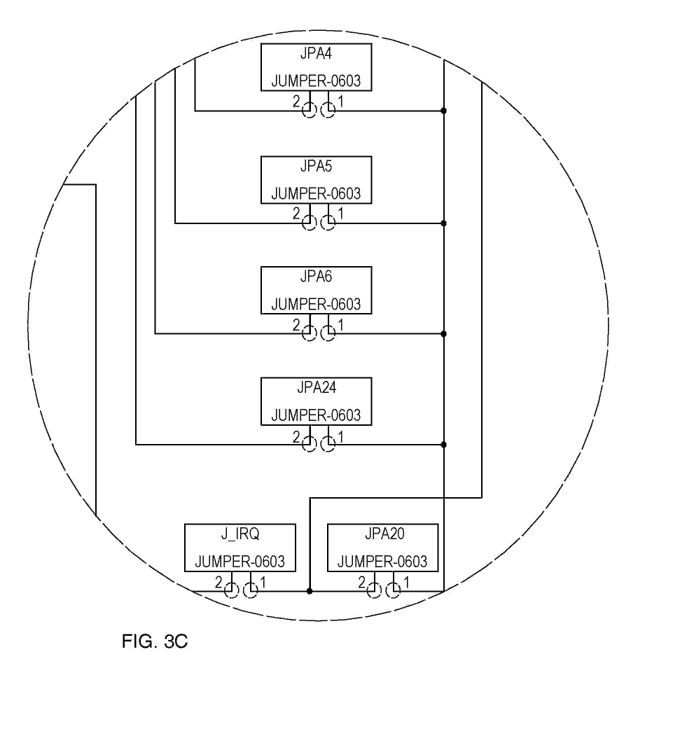

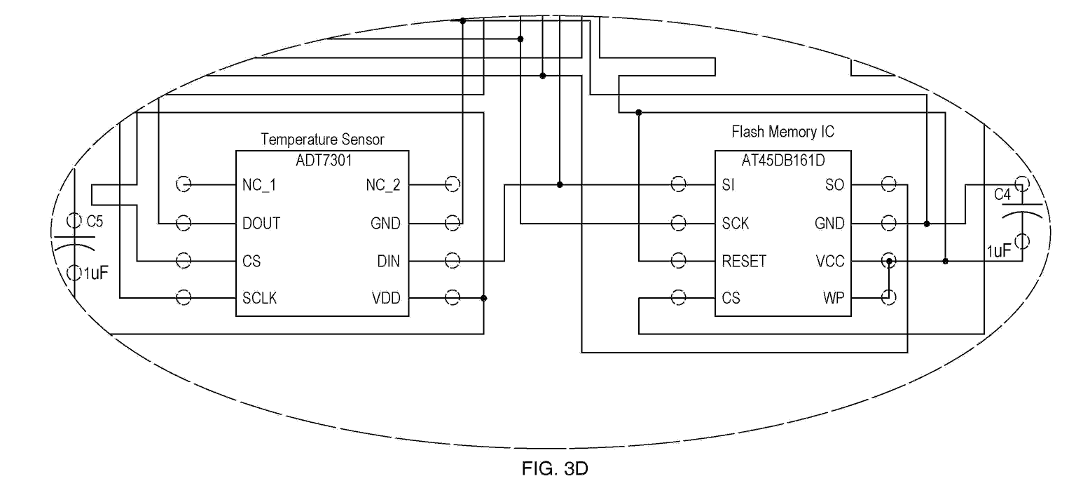

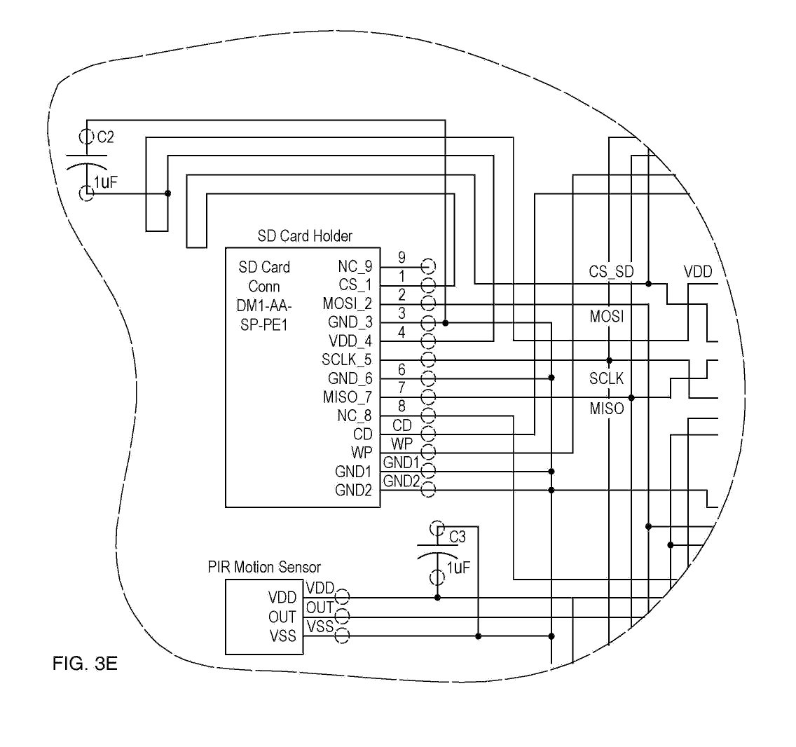

FIGS. 3A-E are a schematic of an embodiment of data log expansion circuit board for the Plug device, according to another aspect of the present invention. Additional expansion modules have included a full spectrum light sensor array, inflatable privacy indicator, accelerometer, LCD display, and sound localizing microphone array, among others.

To complement the fixed network of Plug nodes, a more standard sensor node, called the “Lug”, was also developed based on the same microprocessor, radio, and code base. In this way, the Plugs act as the always-on backbone network among which Lugs are put to use as wearable or battery powered sensor nodes. The microprocessor and all subsystems support low power modes suitable for such battery-powered applications. The Lug's primary use is prototyping on-body or otherwise mobile sensor nodes that interact with the surrounding fixed Plug network. The Plug system also can talk to other wireless devices that are nearby. A small companion node that can be battery powered (or embedded into other devices) has been designed that communicates with the Plug platform. This node, known as a Lug, is a small wireless, battery-powered device that interfaces with the Plug device. The Plugs in this interpretation are essentially base stations for the Lugs. Lugs can be also wearable, allowing particular individuals to be tracked as they move about, or allowing sensor data taken from individuals (e.g., motion, audio, gesture, video, images, temperature, biomedical data, etc.) to be incorporated into the Plug network.

The Lug's small form factor and fast prototyping amenities place the Lug closer to a more traditional sensor network node and complement the fixed network of Plug nodes. That is, the Plugs act as the always-on backbone network among which Lugs are put to use as wearable or battery powered sensor nodes. The prototype Lug exposes all of the Atmel AT91SAM7S64's analog and digital pins in a throughhole fashion appropriate for standard headers. The same radio board found on the Plug can be attached either to the back of the Lug or as a protruding extension. The Lug is USB 2.0-ready and, by populating it with a 5VDC to 3.3VDC regulator, can draw power directly from a USB host. The microprocessor and all subsystems support low power modes suitable for such battery powered applications, although that has not been the focus of the Lug's use thus far. The Lug's primary use is prototyping on-body or otherwise mobile sensor nodes that interact with the surrounding fixed Plug network.

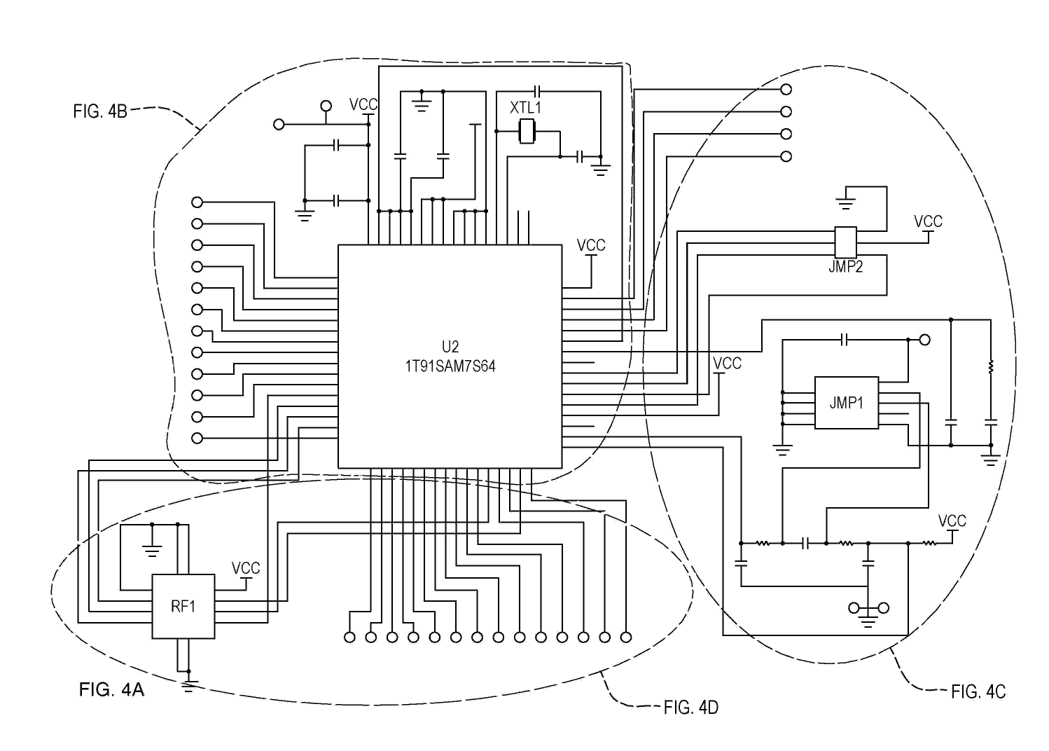

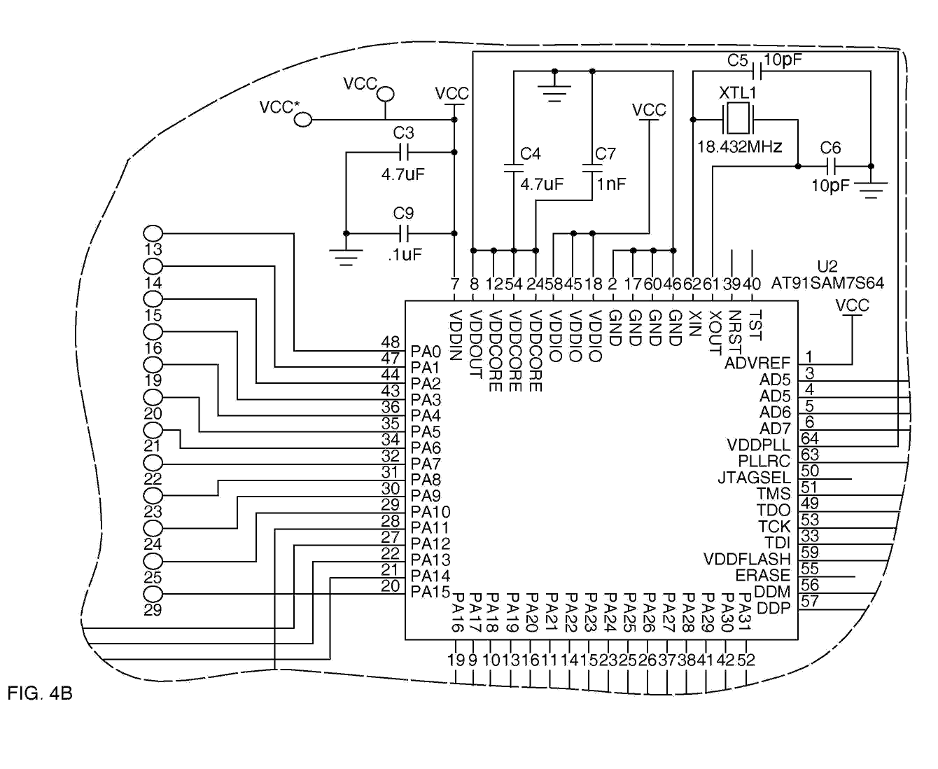

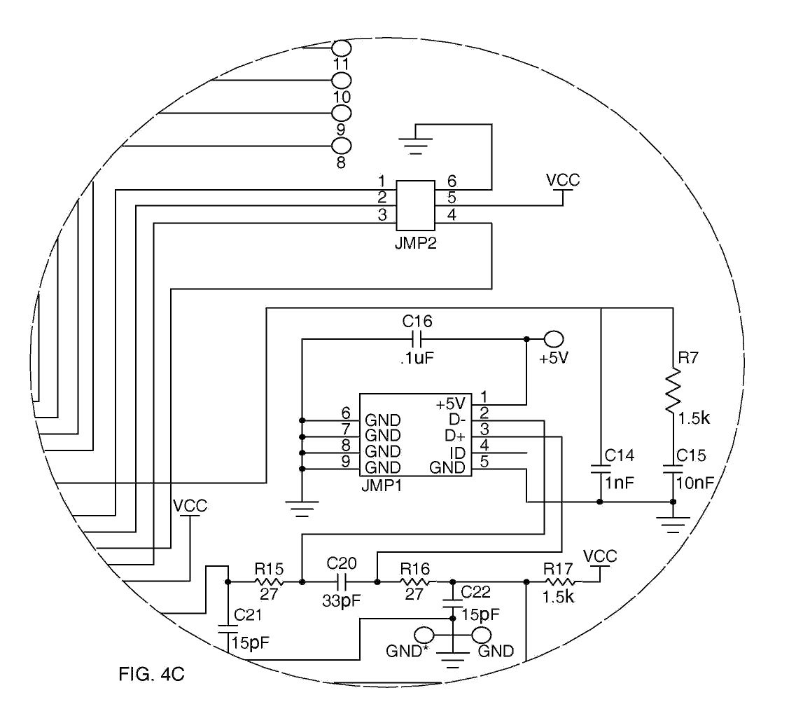

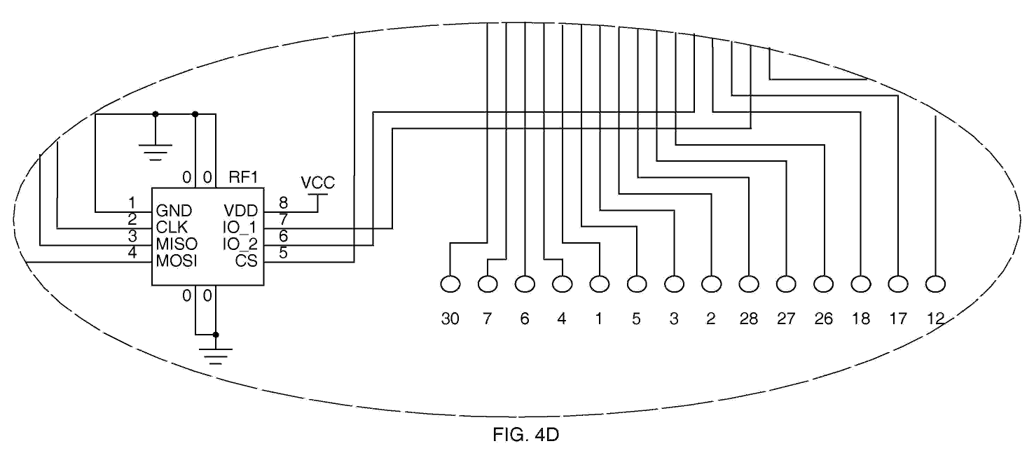

FIGS. 4A-D are a schematic of an exemplary embodiment of a Lug, according to another aspect of the present invention. The Lug uses the same processor and radio as the Plug. The radio can be mounted on the back of the Lug to maintain a small footprint or as an extension of one end of the Lug, in this image the right end. Adding a 5V to 3.3V regulator allows the Lug to be powered directly over USB.

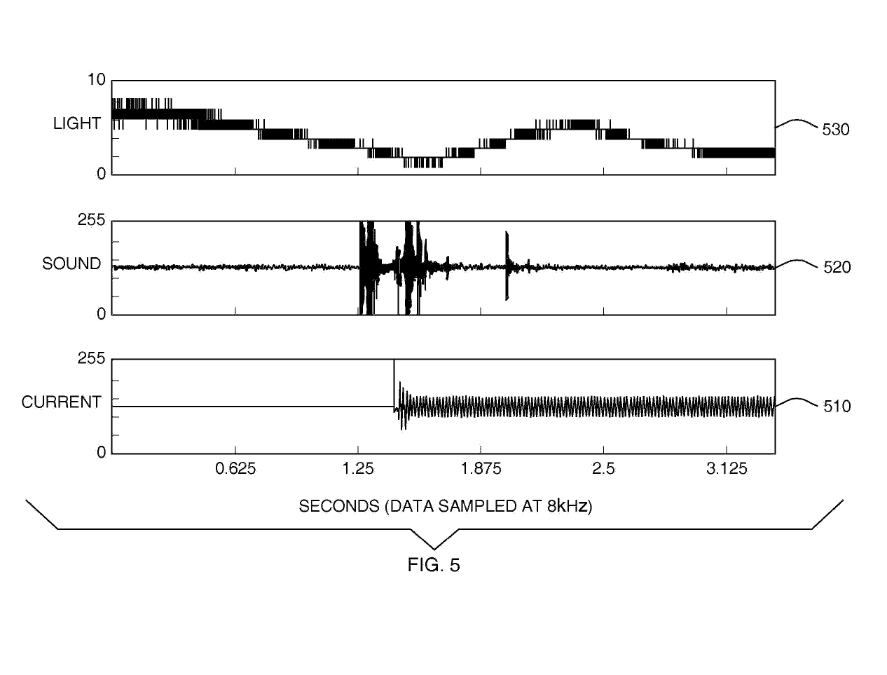

FIG. 5 depicts data taken from a single Plug during a rudimentary scenario, wherein a desk lamp is plugged into one of the Plug node's electrical outlets and turned on. The vertical axes are in arbitrary units. The vertical axis of the “Light” plot has been scaled to show greater detail. All data were sampled at 8-bit resolution. Even scenarios as simple as this make clear the value of the Plug's multi-modal sensing abilities for disambiguating the context of the event. For example, the current sensor data 510 indicate precisely when the lamp was turned on, but cannot be used to discern whether or not the lamp was already plugged in but turned off. The microphone data 520, on the other hand strongly indicate the event included the lamp being plugged into the outlet. This is further corroborated by data 530 from the light sensor, which show the shadow of the hand passing over the Plug as the lamp is being plugged in. These hypotheses are strengthened by looking at the binary motion and vibration indicators. Finally, given that a lamp was plugged in, which might be inferred directly by a more detailed analysis of the current signature, it can be surmised from the relatively constant light reading that the lamp is not shining on the Plug directly and may be far removed due to an extension cord, as was the actual case.

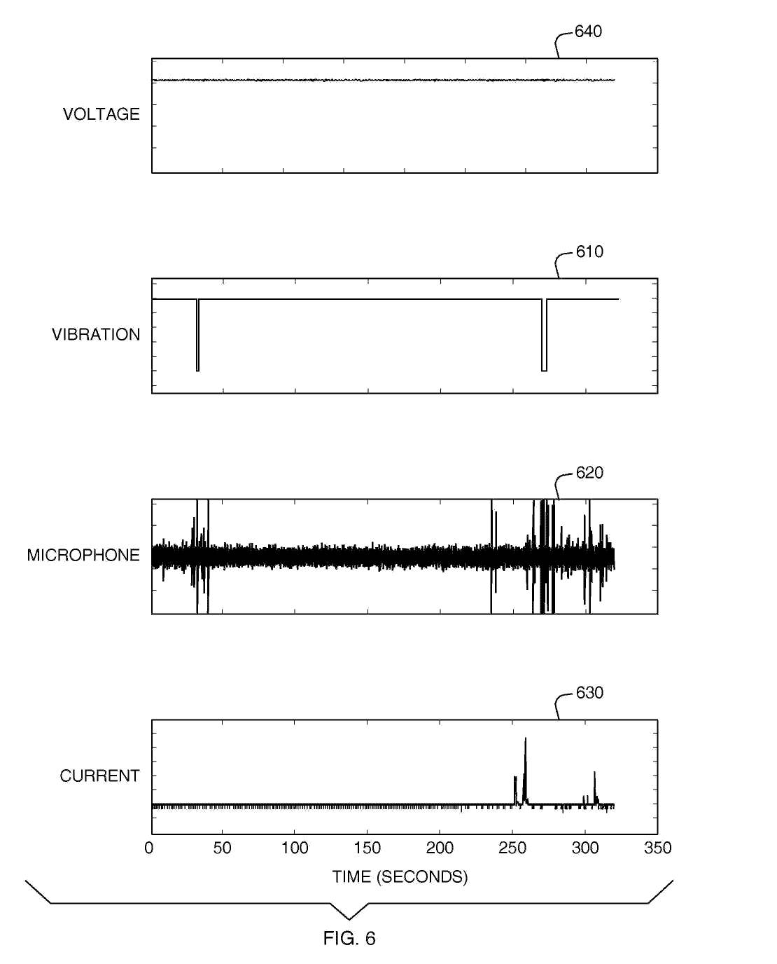

FIG. 6 is an embodiment of example data obtained using a prototype embodiment of a Plug device according to the present invention. The data was taken from the snack vending machine on the third floor of the Media Lab at night. There are three distinct events. First, someone walks by and hits the machine, as seen in vibration graph 610. Second, two people in conversation buy a snack using a dollar bill. Third, the change from the dollar bill is used to buy the same snack. For each purchase, there are two current spikes, one for the exchange of money, and one for the actuation needed to dispense the snack. Conversation ensues throughout, as depicted on microphone graph 620. The current 630 and voltage 640 plots are low-passed, peaked versions of the actual AC measurements. All data have been scaled appropriately for ease of viewing. All sensors were sampled at 500-Hz at 8-bit resolution, except the vibration sensor, which takes on a binary value.

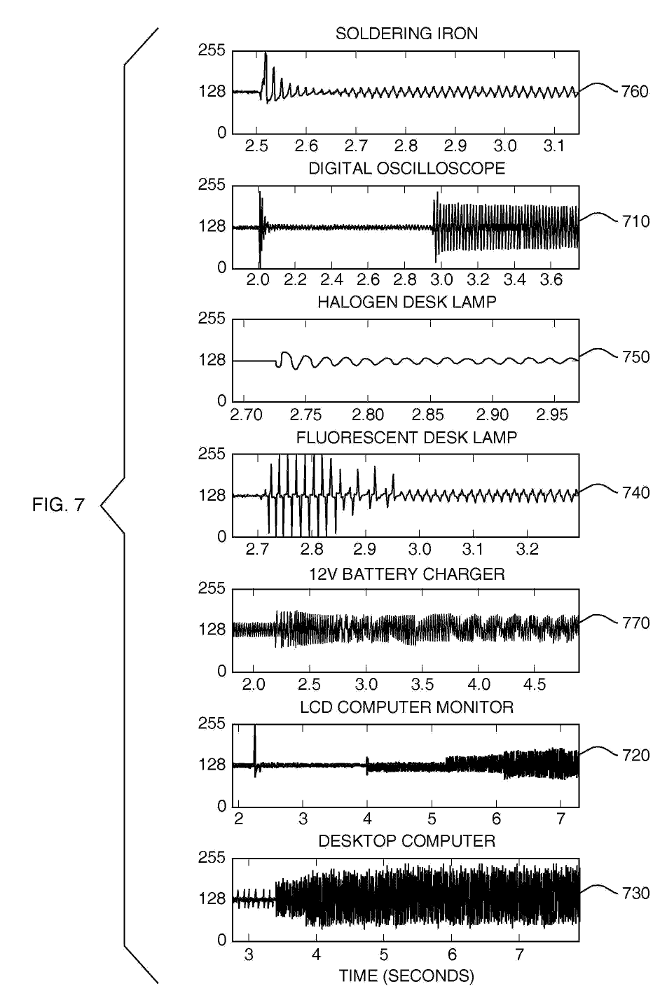

In FIG. 7, plots of current versus time taken from a Plug sensor node are shown for a variety of common electronic devices, including digital oscilloscope 710, LCD monitor 720, desktop computer 730, fluorescent desk lamp 740, halogen desk lamp 750, soldering iron 760, and battery charger 770. Each plot shows current data from a several second window encompassing the time at which the device was plugged into the Plug node's electrical outlet. All data were sampled at 8 kHz. All data are in arbitrary units. FIG. 7 clearly shows how individual and classes of electronic devices can be identified and classified by their current signature alone. For example, the digital oscilloscope 710, LCD monitor 720, and desktop computer 730 all have distinctive, predictable startup sequences. The ballast of the fluorescent desk lamp 740 must power up before the gas in the bulb will fluoresce, whereas the halogen desk lamp 750 is an almost purely resistive load and therefore its current draw is proportional the voltage applied.

Naturally, not all inferences can be made at the node level; some inferences are either too computationally demanding or in need of extra information. In this case, a likely solution is to reduce the raw data to features at the node level and then communicate these features elsewhere for further processing. As proofs of concept, simple versions of such algorithms have been developed for the Plug by other researchers in the lab to classify types of light (e.g. fluorescent, incandescent, halogen, and natural) and types of electrical devices (e.g. resistive, switching, and inductive).

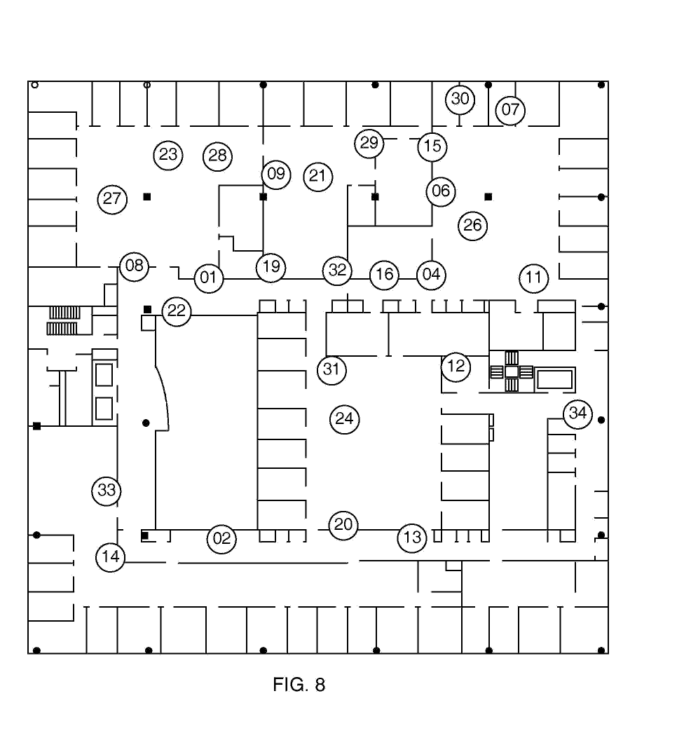

Looking at the network as a whole, general trends of activity across the building are easily seen. FIG. 8 depicts a map of the third floor of the MIT Media Lab and the locations of each Plug during an experimental data collection run lasting about 20 hours starting very early Monday morning and going until late Monday night. In FIG. 8, the 31 large circles indicate the location of Plug sensor nodes. The number within each circle is the ID of the Plug at that location. The darker the circle, the more activity occurred at that node over the span of a 20-hour data collection period. Here, “activity” is defined as the sum of the number of motion sensor and vibration sensor activations.

For this run, 31 of 35 Plugs were deployed. The data collected from each Plug include five-second windowed and rectified minima, maxima, and averages of light, sound, voltage, and current, as well as cumulative motion and vibration activations (the motion and vibration sensors being binary) and the route by which the network packet arrived to its destination. The samples from which the extrema and averages were calculated were taken at 8 kHz. The shade of each circle represents the total “activity” seen over the entire course of the data collection, where activity is defined as an equally weighted sum of total motion and total vibration activations. All data were routed to a single Plug over the radio network (the dark circle in the upper right corner, number 18) and siphoned on to a personal computer via a single USB connection. This graph of activity level corresponds well with how active different parts of the building appear to be. For example, Plug 03 was placed next to a heavy door leading to the main kitchen and cafe area, making its high activity level unsurprising.

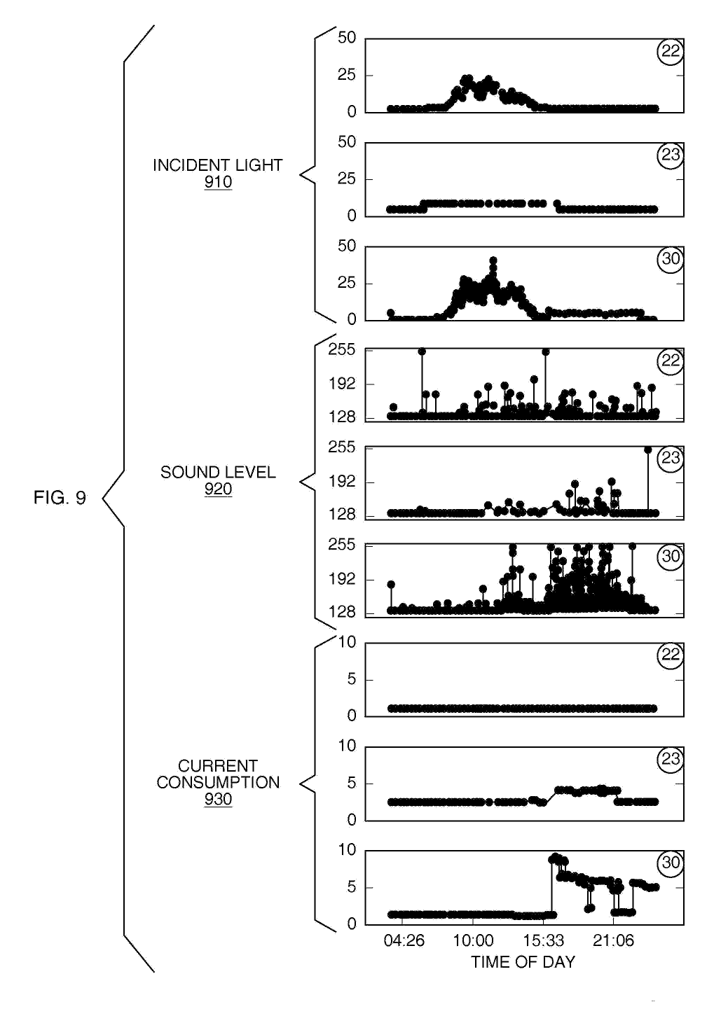

FIG. 9 shows light 910 (maximum over five-second window), sound 920 (maximum over five-second window), and current 930 (average over five-second window, averaged across all four outlets) data versus time of day from three specific Plugs during the same data collection period. In FIG. 9, the circled number in the upper right-hand corner of each graph is the ID of the Plug and corresponds to the location shown in FIG. 8. All data are in arbitrary units. In this case, trends taking place over an entire day become apparent. For example, the light readings from Plugs 22 and 30 clearly show the sun rising and setting. (Although the map indicates Plug 22 is located near the middle of the building, it was placed next to a window that overlooks a large atrium with sky lights). Plugs 23 and 30 show office lights being turned on and off, albeit at different times of day. The current draw from Plug 30 shows a desktop computer being started, shutdown, and rebooted at various points in the evening, whereas Plug 23 only had small DC converters plugged into it. The sound level graphs indicate discrete events (spikes in the graph) and general activity level. The several visible gaps in Plug 23's data sets are cases of packets being dropped in the network. In general, packet loss increased with increased network distance from the data collection node, most likely due to node-to-node packet transfer being unacknowledged. The most recent version of the Plug networking software makes use of acknowledged packets.

In a preferred embodiment, the Plug contains two major parts: a low voltage board and a high voltage board. In a preferred embodiment, the low voltage board of the present invention employs an Atmel AT91SAM7S64 microcontroller with an ARM7TDMI core, a CC2500 transceiver and sensors. The high voltage board mainly functions as a programmable current provider to each outlet and to the low voltage board. In addition, it includes fuses and safety devices.

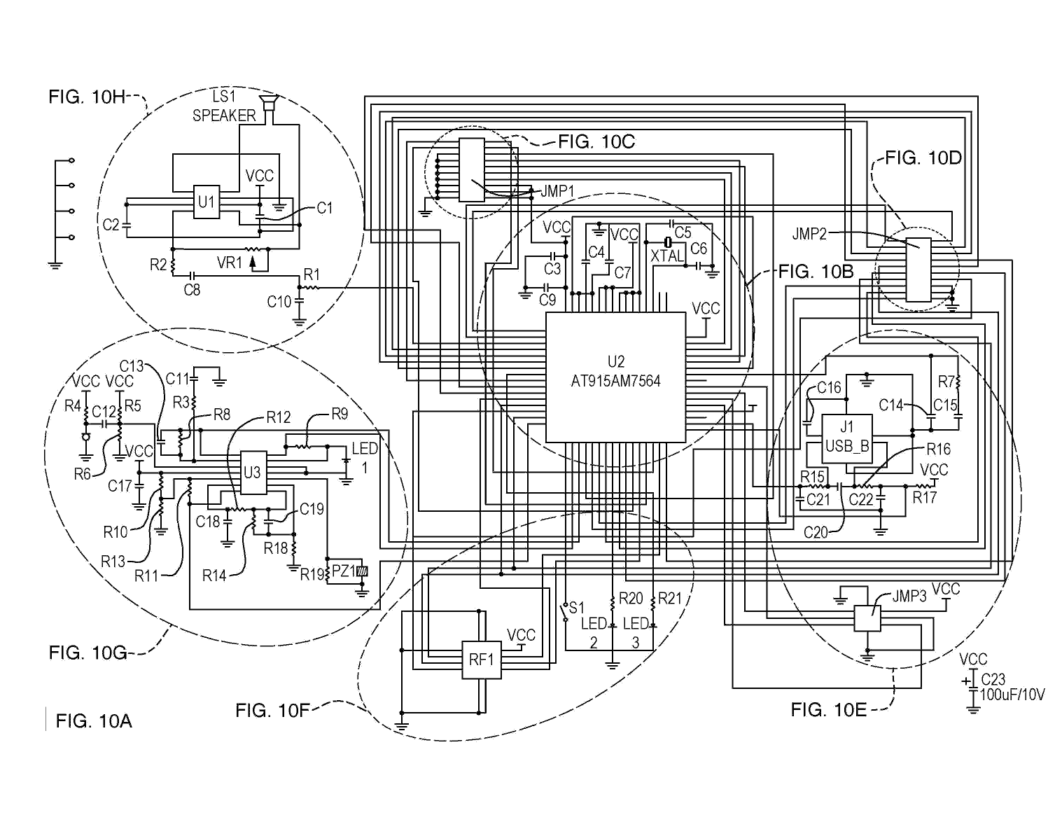

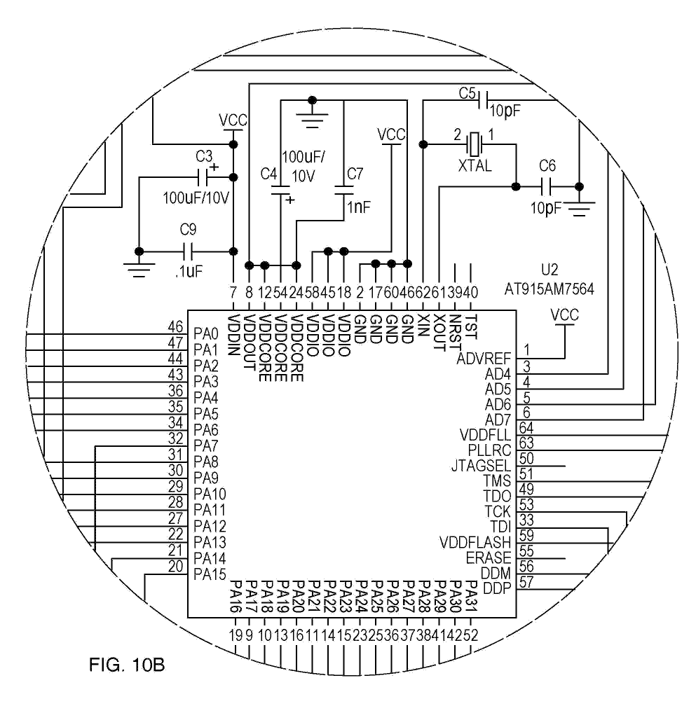

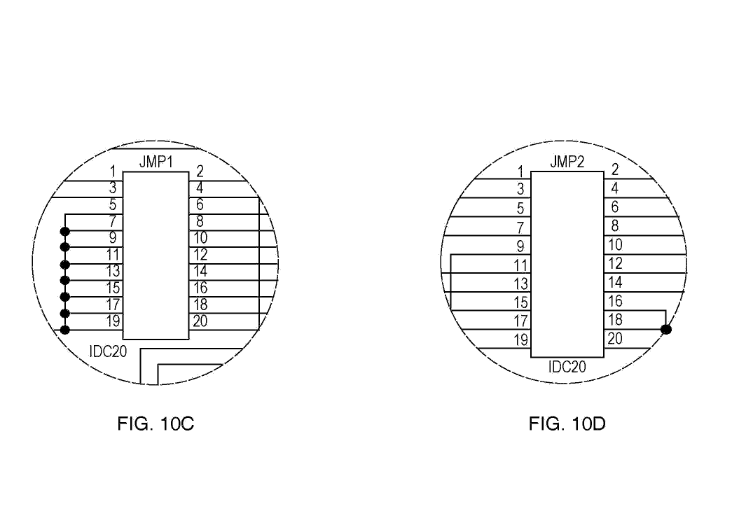

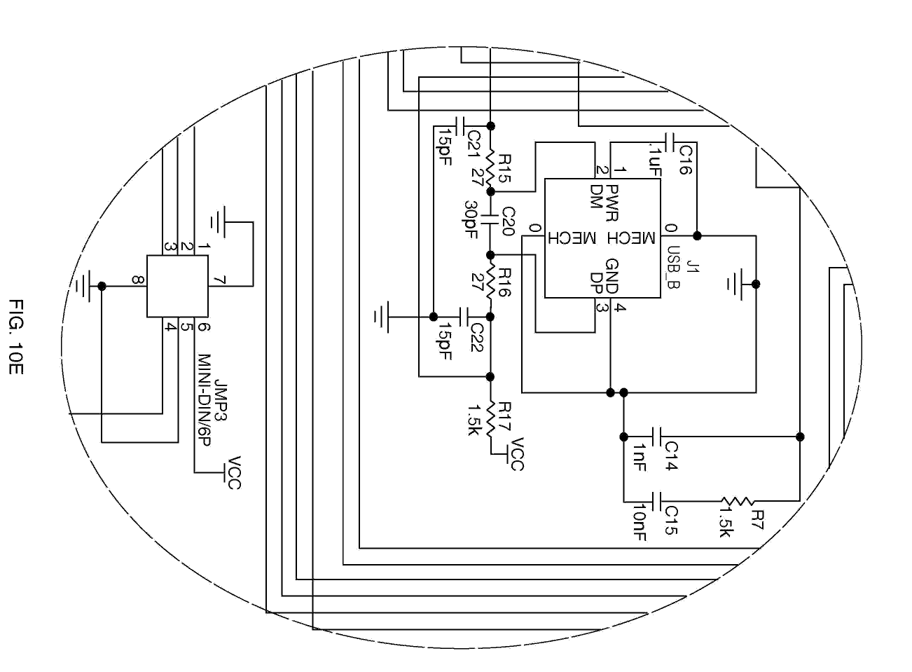

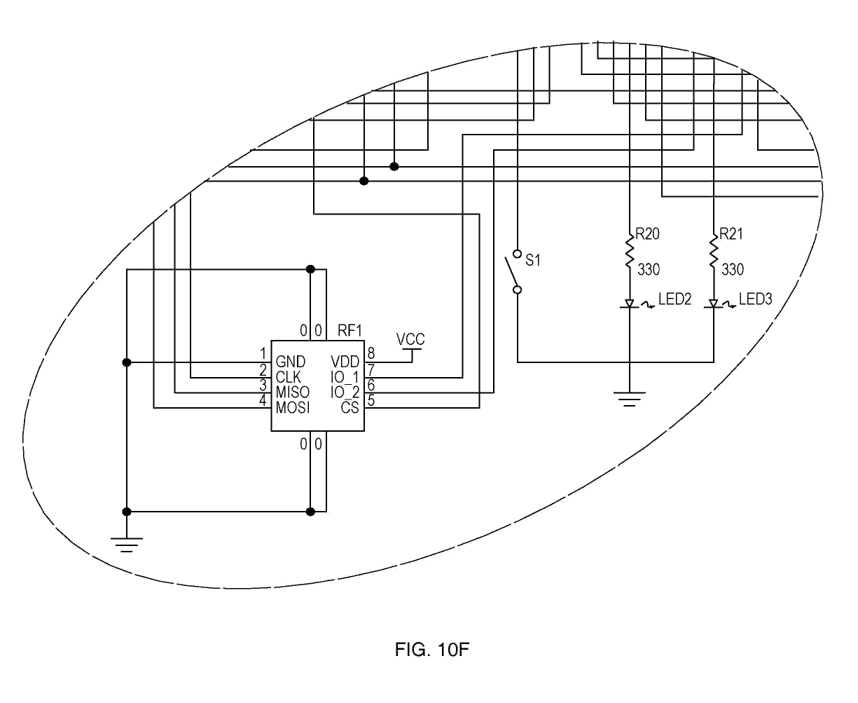

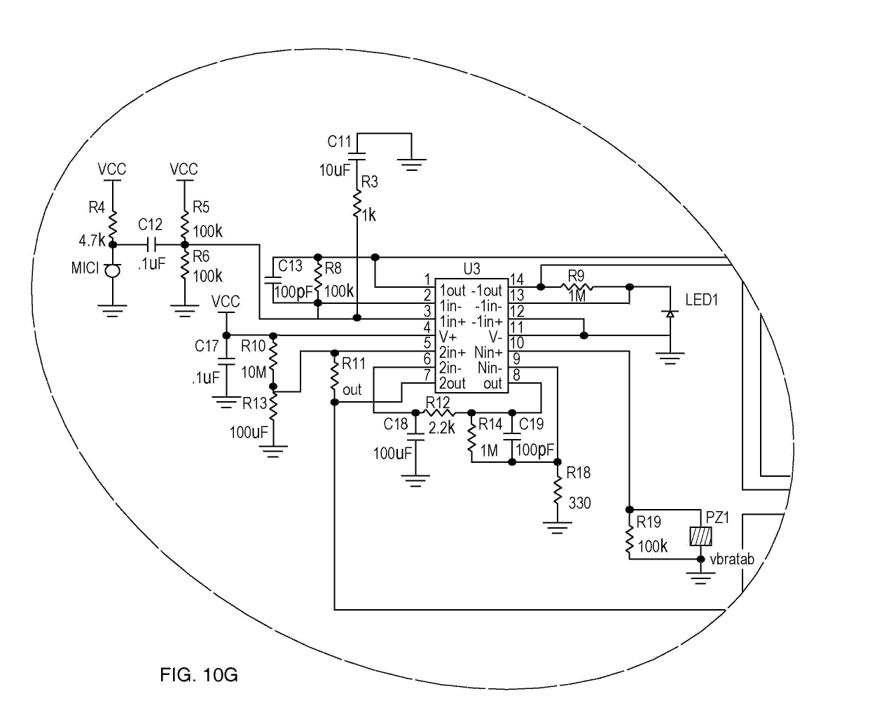

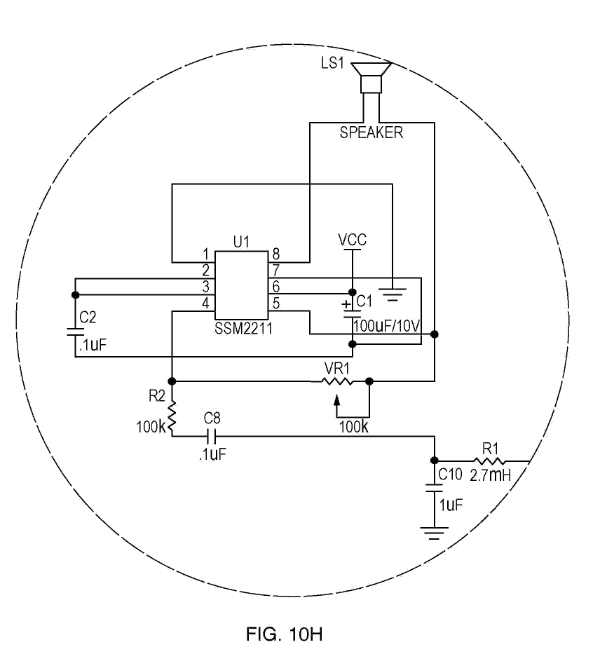

FIGS. 10A-H are a schematic of an exemplary embodiment of a low voltage Plug board according to the present invention. Table 1 lists important parts in an exemplary embodiment of the low-voltage board for the Plug.

TABLE 1
Parts

Atmel ARM7-based AT91SAM7S64 microcontroller
Analog Devices SSM2211 low distortion 1.5 Watt audio power amplifier
Knob to control the volume of the speaker
JTAG interface for programming and debugging the microcontroller
USB connector
Two LEDs
Phototransistor sensor
Audio microphone
Vibration sensor
Chipcon CC2500 2.4 GHz RF transceiver

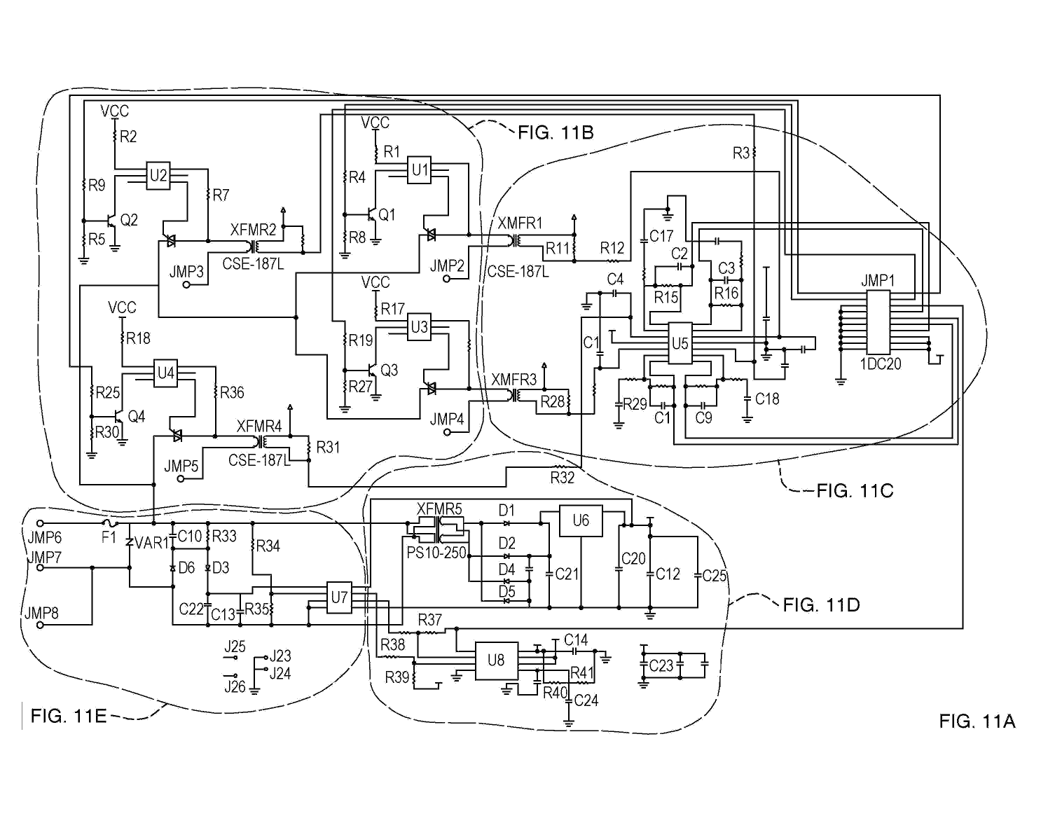

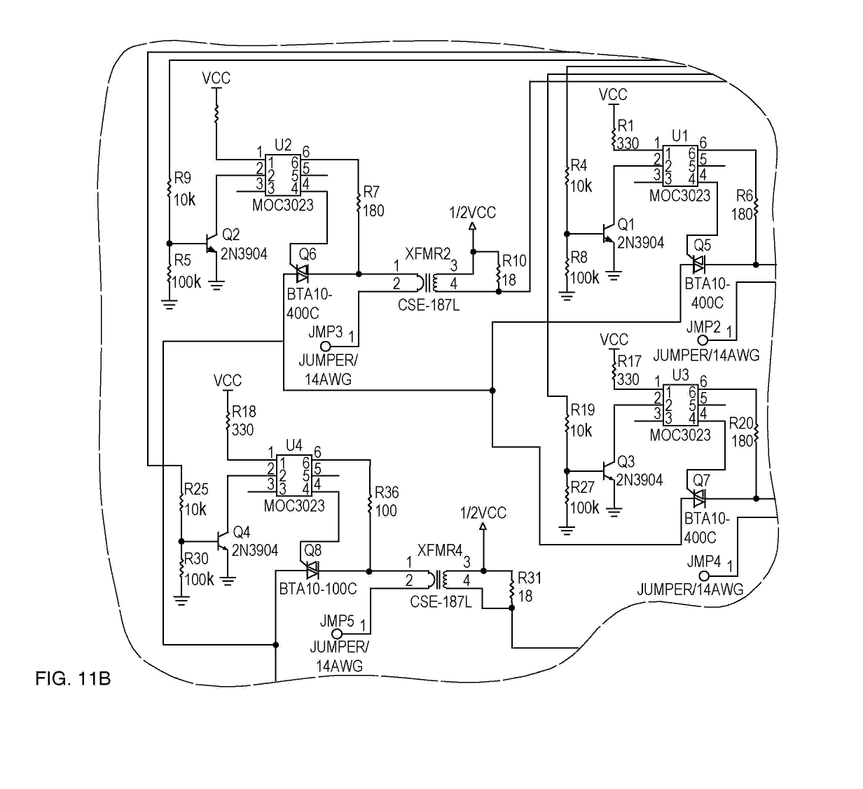

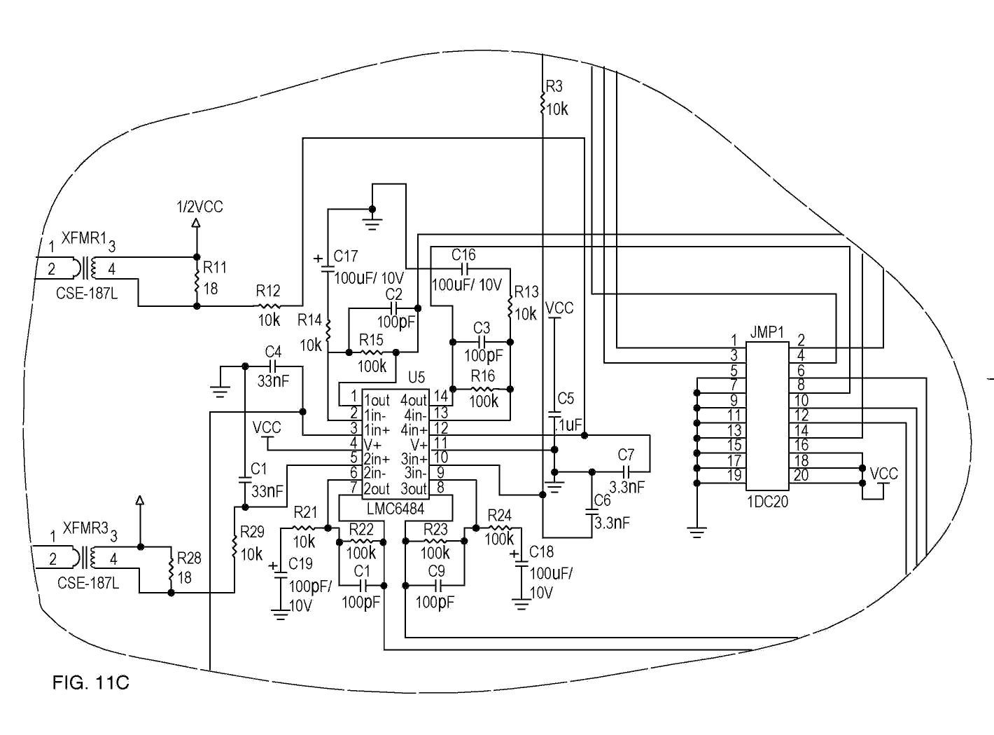

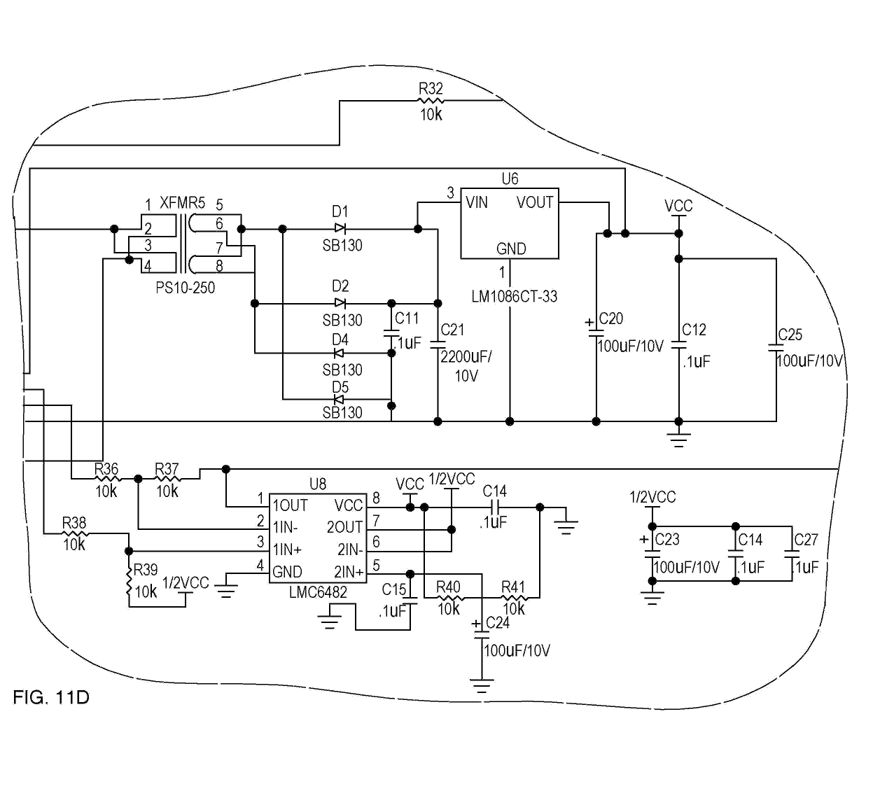

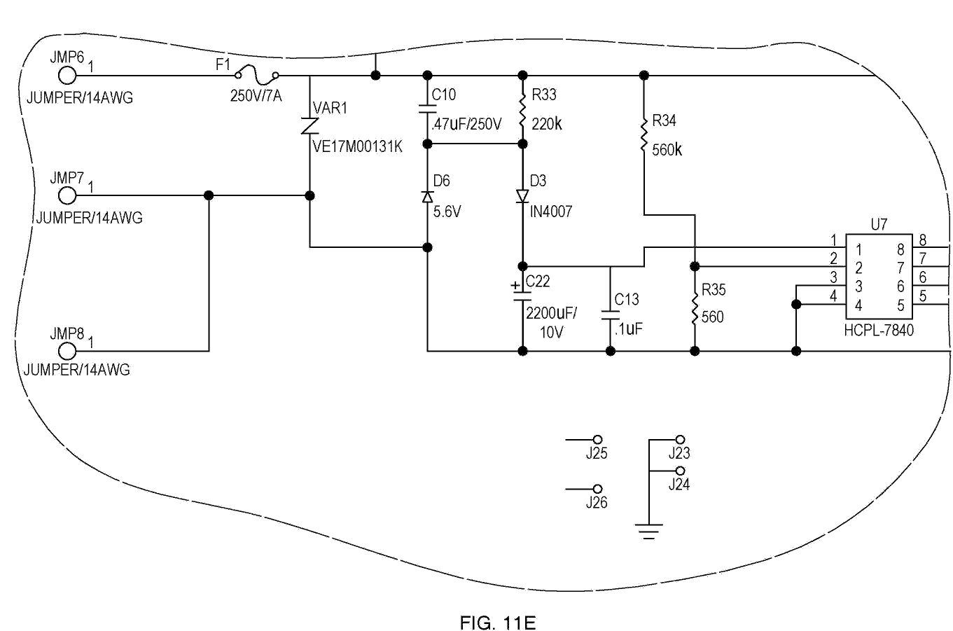

FIGS. 11A-E are a schematic of an exemplary embodiment of a high voltage Plug board according to the present invention.

Significant effort was put into accommodating all the features of the Plug while still maintaining the highest safety standards. To begin with, the Plug case is a sturdy die cast aluminum box that can easily support the weight of several adults jumping up and down on it. The prototype Plug node's ungainly aluminum case is a conservative design tailored for rapid construction and safe operation within the lab. A preferred design for mass production has the sensors more seamlessly integrated into what looks more like a conventional power strip. Internally, the Plug comprises two separate circuit boards, one that handles all high voltage signals, such as voltage sensing, and another that handles only low voltage digital signals, such as driving the speaker. All components protruding from the case, except for the outlets themselves and the power cord, have connections only to the low voltage board. A transformer on the high voltage board supplies up to 500 mA at 3.3V to the low voltage board and expansion port. No high voltage signals are externally accessible through the expansion port or otherwise. The apertures in the case are precision cut by a waterjet cutter to ensure a tight fit around all protruding components. As is standard with conductive enclosures, the entire Plug case is grounded. The total current sourced by a Plug is limited by a slow-blow 8A fuse, which precludes using high current appliances such as heaters. As well as being a safety precaution, the fuse also protects the triac switches from being over driven.

In one embodiment, the Plug system employs a microphone for audio, a simple accelerometer for detecting vibration, a temperature sensor, and a light sensor. Other sensors can be built into the Plug, such as, but not limited to, a motion sensor, for which an expansion card that integrates Passive InfraRed (PIR) motion sensors into the Plug may be employed, enabling presence of nearby people to be sensed, Doppler or impulse radar, a miniature camera for taking images or video, and any other kinds of environmental sensors (e.g., chemical sensors, radiation sensors, etc.). The Plug supports a set of simple controls (a button that can be mapped to any arbitrary purpose, sliders, etc.), and may optionally also include a simple display of any type known in the art including, but not limited to, programmable LEDs or simple LCD. The Plug may also incorporate an active IR system for detecting and communication with devices that are nearby, in a line of sight. The Plug also is an actuator in addition to being a sensor. It includes a speaker for playing arbitrary digital audio streams and samples (either stored onboard or sent over the network), and it can control the voltage independently at each supported outlet via a digital dimmer circuit.

Although not all Plugs need to perform networking over the power line, and some embodiments may use a custom RF transceiver with custom protocol exclusively, both power line and RF communication can be used (separately or together) in this device. Communication over the power line provides an intrinsic data bus that can link all Plugs in a home or office building together. Many power line protocols exist in the art that are appropriate for such communication (e.g., X-10, etc.).

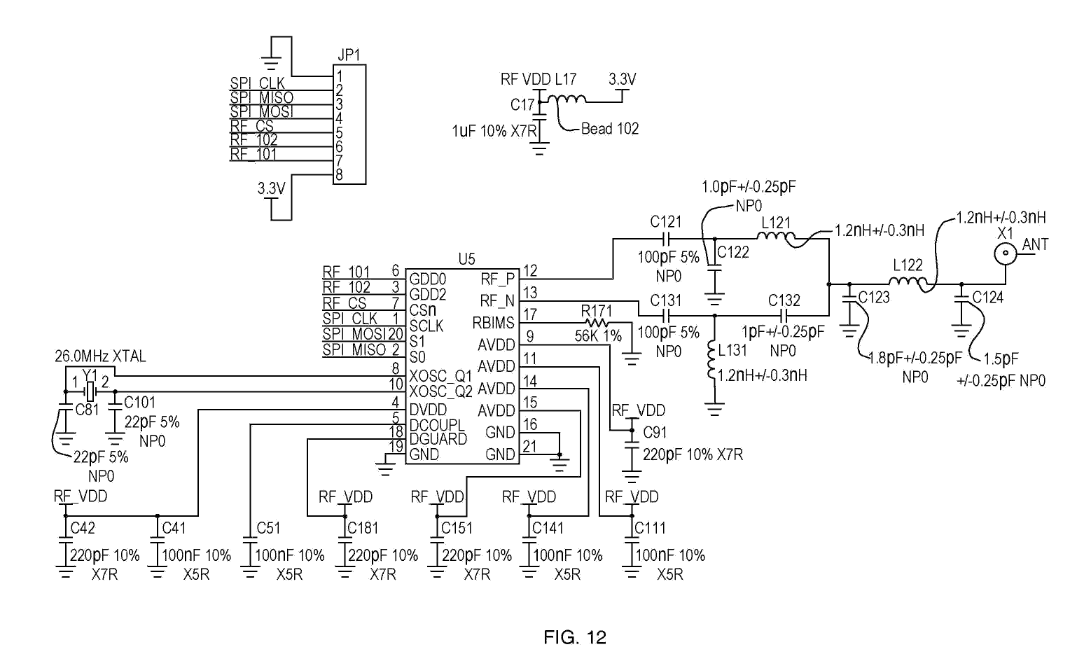

For wireless networking, the Plug uses a simple carrier sense multiple access (CSMA) scheme with random backoff upon collision detection and a straightforward gradient routing scheme evolved from the code base that was developed for the Pushpin Computing platform [J. Lifton, D. Seetharam, M. Broxton, and J. Paradiso. Pushpin Computing System Overview: a Platform for Distributed, Embedded, Ubiquitous Sensor Networks. In F. Mattern and M. Naghshineh, editors, Proceedings of the International Conference on Pervasive Computing, pages 139-151. Springer Verlag, August 2002]. The Plug's wireless networking was designed to allow for simple communication between network-adjacent nodes and data collection with arbitrary nodes in the network simultaneously serving as base stations. Only a single base station was used, but with this networking scheme any number of the Plugs could just as easily act as a network-wide data sink. FIG. 12 is a schematic of an exemplary embodiment of a radio circuit board for a Plug according to an aspect of the present invention.

The software running on the Plug microcontroller includes interrupt-driven, double-buffered modules for interfacing to and managing the SPI bus, GPIO pins, radio, USB port, ADC, speaker, LEDs, push button, real-time clock with set-table alarms, SD memory card, vibration and motion sensors, random number generator, data flash, and temperature sensor. At present, applications are pieced together from these modules predominantly through the use of asynchronous callbacks. Since the Plug platform is essentially free of energy constraints (rate of consumption is limited, but not cumulative consumption), the Plug software modules are designed to be time efficient, not energy efficient. For example, the default behavior of the ADC module is to continuously sample all eight analog channels at 8 kHz with 8-bit resolution in a 256-byte buffer per channel with logging of periodic averages, minima, and maxima over several seconds. If needed, a single ADC channel can be configured to sample at as high as 191 kHz and with 10 bit resolution, such as might be required, for example, to distinguish different kinds of fluorescent light ballasts [S. Ben-Yaakov, M. Shvartsas, and S. Glozman. Statics and dynamics of fluorescent lamps operating at high frequency: Modeling and simulation. IEEE Transactions on Industry Applications, 38(6):1486-1492, November December 2002]. However, even without tight energy constraints and all subsystems active, the Plug only draws approximately 60 mA at 3.3V.

The firmware running on the Plug microcontroller was written from scratch, with some aspects of its design, especially regarding networking, derived from the Pushpin Computing platform [Joshua Lifton, Deva Seetharam, Michael Broxton, and Joseph Paradiso. Pushpin Computing System Overview: a Platform for Distributed, Embedded, Ubiquitous Sensor Networks. In Proceedings of the International Conference on Pervasive Computing, pages 139-151, August 2002]. The firmware is optimized for and makes extensive use of many of the AT91SAM7S64's hardware peripherals, such as the direct memory access (DMA) controller, pulse width modulator (PWM) controller, and serial peripheral interface (SPI) controller. In particular, the firmware includes interrupt-driven, double-buffered modules for interfacing to and managing the SPI bus, GPIO pins, radio, USB port, ADC, speaker, LEDs, push button, real-time clock with settable alarms, SD memory card, vibration and motion sensors, random number generator, data flash, and temperature sensor. The Plug firmware was developed using Rowley Associates'Cross-Works for ARM version 1.5 for Linux tool chain. Applications, set at compile time, are pieced together from these modules predominantly through the use of asynchronous callbacks.

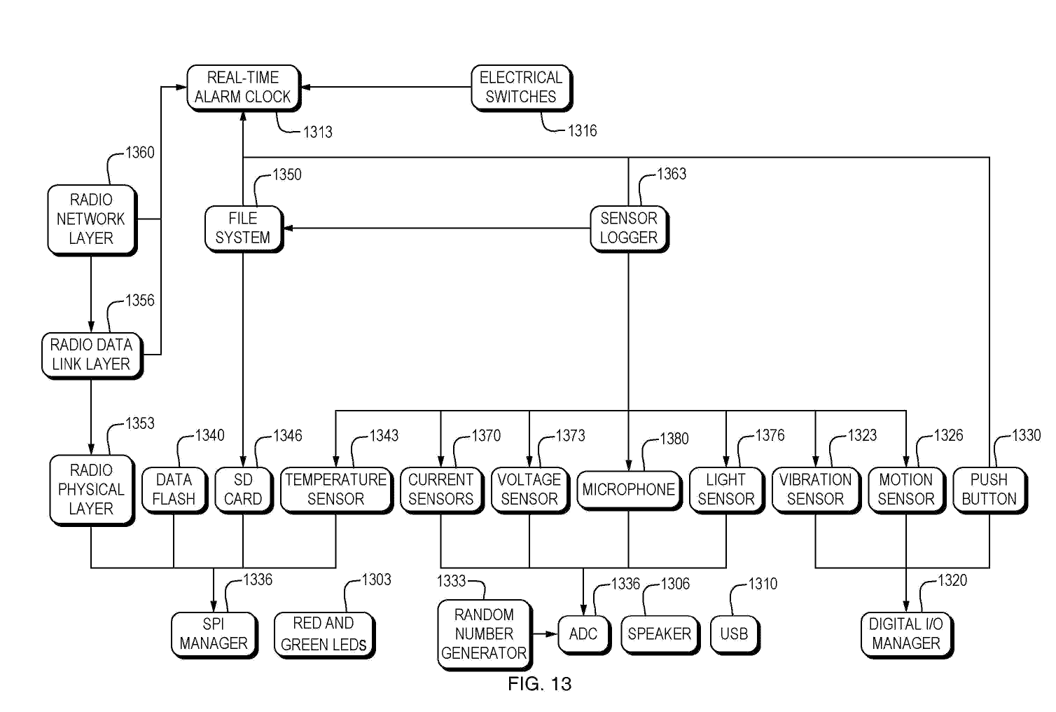

FIG. 13 is an overview of an embodiment of the firmware structure, according to one aspect of the invention. In this embodiment, the modules are Red and Green LEDs 1303, Speaker 1306, USB 1310, Real-time Alarm Clock 1313, Electrical Switches 1316, Digital I/O Manager 1320, Vibration Sensor 1323, Motion Sensor 1326, Push Button 1330, Random Number Generator 1333, SPI Manager 1336, Data Flash 1340, Temperature Sensor 1343, SD Card 1346, File System 1350, Radio Physical Layer 1353, Radio Data Link Layer 1356, Radio Network Layer 1360, Sensor Logger 1363, ADC 1366, Current Sensors 1370, Voltage Sensor 1373, Light Sensor 1376, and Microphone 1380.

Red and Green LEDs: Each LED is independently controlled by a dedicated 16-bit PWM channel updated at 45.7 Hz. Patterns can be played by passing to the LED module a function that is called every PWM period. Thus, patterns can be generated algorithmically or read directly from memory. Patterns can also be repeated and interrupted. An interrupt-driven LED manager updates the PWM duty cycle every period until the pattern stops or the LED is turned completely on or off. Included with the LED module are patterns for blinking, pulsing, and fading the LEDs.

Speaker: A dedicated 8-bit PWM channel feeds into a two-pole passive LC low-pass filter tuned to a 20 kHz 3 dB point to produce the output waveform played by the speaker. The frequency of the PWM is 187.2 kHz and the duty cycle is updated at 8 kHz. The scheme for playing sounds is nearly identical to that of playing light patterns on the LEDs. The speaker can play single-channel, 8-bit, 8 kHz WAV files from the file system module or replay recorded sound from the microphone. Included with the speaker module are sounds for white noise and a 200 Hz tone.

USB: The microcontroller acts as a USB 2.0 device operating in bulk transfer mode. Other transfer modes are possible, but not implemented. The microcontroller cannot serve as a USB host. Data transfer to and from the host is interrupt-driven. The data rate is largely dependent on the overhead incurred by the host for making a transfer. For example, in a typical set up, the fastest the host can query the device is once every 2 milliseconds. Thus, due to the high speed of USB 2.0, there is no difference in the time it takes for the host to receive 1 byte or 1000 bytes since both transfers complete within a 2 ms window.

Real-time Alarm Clock: A 16-bit hardware timer forms the basis of a 64-bit clock reset to zero upon start up and incremented once every 2.67 microseconds thereafter. The current time can be safely retrieved at any point. An arbitrary number of alarms can be set to trigger arbitrary callback functions. Alarms are guaranteed to trigger only after the specified time and a best effort is made to trigger them as soon after the specified time as possible, depending on interrupt latencies. Alarms can also be unset without causing them to trigger.

Electrical Switches: Each of the four electrical outlets can be independently turned on or off by means of a triac controlled by a digital I/O pin. One of the four switches can be controlled by an interrupt-driven software PWM. The same functionality could be easily extended to the other three outlets, but is not yet implemented. All electrical outlets are on by default after start up or processor reset.

Digital I/O Manager: Any firmware requiring notification of digital input pin change interrupts, such as the push button, receives such notification by first registering with the digital I/O manager module. The digital I/O manager also facilitates the use of pins as outputs.

Vibration Sensor: The vibration sensor interfaces with the microcontroller through a single digital input pin that can either be polled directly or configured to trigger a pin change interrupt. When vibration is sensed, the input pin is driven low, referred to as the active state. The duration of the active state indicates either continuous vibration or the amplitude of a single impulse.

Motion Sensor: The passive infrared (PIR) motion sensor detects change in the heat incident upon a wide-angle plastic lens and can easily detect the motion of a person within a couple meter radius. Like the vibration sensor, the duration of the active state (also low) indicates either continuously changing incident heat or, more probably, the amplitude of the change. The motion sensor can be polled directly or configured to trigger a pin change interrupt.

Push Button: Configurable function callbacks are triggered whenever the push button is depressed or released. Both events are automatically debounced with a 50 millisecond interrupt-driven wait time. Depressing and releasing the button five times within two seconds will cause the Plug to reset.

ADC, Current Sensors, Voltage Sensor, Light Sensor, and Microphone: For simplicity and flexibility, the default behavior of the analog-to-digital converter (ADC) is to continuously sample the light sensor, voltage sensor, microphone, and four current sensors at 8 kHz per channel with 8-bit resolution. The ADC interfaces to the direct memory access (DMA) controller to automatically store samples in a memory buffer large enough to hold 64 samples per channel. Once the first buffer is filled, subsequent samples are automatically placed in a second buffer so as not to overwrite previously taken samples while they are being processed by a callback function, after which the roles of the two buffers are interchanged and the process repeated. The default callback function for processing ADC data is part of the sensor logger module. The default ADC configuration can be overridden to have, for example, a single ADC channel sample at as high as 191 kHz and with 10-bit resolution, such as might be required to distinguish different kinds of fluorescent light ballasts.

Random Number Generator: The random number generator module provides pseudorandom numbers in a variety of formats by using the standard C library random number generator with an initial seed generated bit by bit by XORing the lowest bit of many ADC samples.

SPI Manager: The microcontroller's serial peripheral interface (SPI) speaks to the radio, temperature sensor, SD card, and data flash, but only one at a time. The SPI manager module coordinates the use of the SPI bus among these four peripherals or others, such as an LCD display, depending on the expansion board used. All SPI communication is interrupt-driven and takes advantage of the DMA controller so entire memory buffers can be received or transmitted without processor intervention.

Data Flash: A 4 Mbit data flash integrated circuit resides on the data log expansion board. Only rudimentary tests have been implemented since the SD card fulfills much of the same functionality.

Temperature Sensor: The 13-bit temperature sensor on the data log expansion board can report temperatures between −40_C and 150_C with a resolution of 0.03125_C and typical accuracy of ±0.5_C at a sample rate of up to once every second.

SD Card: The data log expansion board holds a 1 GB removable secure digital (SD) flash memory card. The SD card module provides interrupt-driven reading and writing of whole and partial 512-byte sectors over the SPI bus.

File System: The entire 1 GB SD card is occupied by a customized file system suited to the specific needs of the Plug. Table 4.1 gives an overview of the file system used. In particular, the root of the file system is the first sector (512 bytes) and contains a 16-bit unique identifier (UID) and a table indicating the occupancy status of the dynamic WAV file table located in the second quarter of the SD card's memory. The first quarter of the SD card's memory except the first sector contains the static WAV file table, comprising an arbitrary number of WAV files, each no greater than 4096 sectors in size. The static WAV file table is set at compile time. The dynamic WAV table occupies the second quarter of the SD card's memory, comprising 128 slots each of 4096 sectors. The dynamic WAV file table can be added to or erased during run time. Each WAV file slot, whether in the static or dynamic table, can hold a single 8-bit, 8 kHz, single-channel WAV sound file up to approximately 4 minutes and 22 seconds in length. Half of the dynamic WAV file slots are designated as “outgoing” and half as “incoming”. Outgoing WAV files are those originating from the microphone or from a neighboring Plug meant to be transferred over the network to an external location for playback. Incoming WAV files are those received over the network meant for local playback on the speaker. The last half of the SD card's memory is devoted to log file entries, each occupying one sector, generated by the sensor logger module.

Radio Physical Layer: The Plug's ChipCon CC2500 2.4 GHz low-power radio interfaces to the microcontroller through an SPI bus and two digital inputs. The radio physical layer module uses a carrier sense multiple access (CSMA) scheme with random backoff upon collision detection to transmit packets and won't accept another packet for transmission until the current packet has been successfully transmitted. A successful transmission does not indicate a successful receipt. Received packets are guaranteed to have passed a 16-bit cyclic redundancy check (CRC) and come with a link quality indicator (LQI) and received signal strength indicator (RSSI). All radio physical layer module transactions are interrupt-driven. As a debugging and network diagnostic tool, a radio profiler records every state the radio passes through and the result of every transmitted or received packet.

Radio Data Link Layer: Using the radio physical layer as a basis, the radio data link layer module manages single-packet transfers between network-adjacent Plugs. Packets can be broadcast to all neighbors or addressed by means of a one-byte locally unique identifier to a single neighbor, in which case it can optionally be certified so as to require an acknowledgement of receipt. Multiple packets can be queued for transmission at the same time and an arbitrary callback function to be called upon transmission success or failure can be associated with each packet in the queue. The one-byte network identifiers can either be randomly generated and checked against neighboring identifiers for uniqueness or, due to the relatively small number of extant Plugs, derived directly from the Plug's two-byte UID. The radio data link layer maintains a list of up to sixteen neighbors, each entry of which contains the neighbor's UID, network identifier, most recent LQI and RSSI measurements, time of the most recently received packet from this neighbor, and a metric for gauging how many certified packets sent to the neighbor were responded to with an acknowledgement packet.

Radio Network Layer: The radio network layer module builds upon the radio data link layer module to provide a routing scheme for delivering packets across the Plug network from an arbitrary number of source nodes to a handful of sink nodes. The basic scheme involves two phases—one for discovering the route from a source to a sink and another for sending packets along that route. Route discovery involves flooding the network with a query that seeds each node with its minimum hop count from the data sink. In one variation of route discovery, only the identifier for the sink and the number of hops from the sink are recorded by each node. Sending a packet to the sink requires following the path (or paths in some cases) of decreasing hop count until the sink is reached using neighborhood broadcast data link layer packets. In a second variation of route discovery, only the address of the next node in the route and the number of hops from the sink are recorded by each node. Sending a packet to the sink requires tracing back the unique path from the source using certified data link layer packets. In both variations, any set of nodes can be dynamically designated as the sinks, the only limitation being the total number of sinks due to memory constraints. The current implementation has a limit of five sinks.

Sensor Logger: All sensor data from each of the ADC channels (light, sound, microphone, voltage, and current) are processed by the sensor logger module to calculate statistics for each sensing modality and periodically record a log of these statistics and other Plug state to the SD card through the file system module. The sensor logger module processes raw sensor samples in batches of 256 samples per sensor channel by calculating the minimum, maximum, and average for the batch for each channel. The most recent batch of 256 raw samples for each sensor channel is always available through a callback function triggered when the batch is finished being sampled. Similarly, the most recent 256 minima, maxima, and averages for each channel are available as well. The completion of every sixteenth set of minima, maxima, and averages triggers the further aggregation of the previous 32 minima, maxima, and averages into a single minimum, maximum, and average for each channel. Eight such aggregates are recorded in each log entry of the file system on the SD card. That is, each log entry on the SD card contains, for each sensor channel, eight minima, maxima, and averages windowed over 1.024 seconds such that consecutive windows overlap by 0.512 seconds. Thus, a log entry is written to the SD card every 4.096 seconds. For each of the eight 1.024-second windows, the number of times the motion and vibration sensors were active when sampled once every 8 milliseconds is also recorded. In addition to these statistics, each log entry also contains a single temperature sensor reading, the number of times the button has been pressed since the last log entry, the radio profiler log maintained by the radio physical layer module, and the list of neighbors maintained by the radio data link layer module.

In one embodiment, the Plug employs new programming framework for sensor networks based on an open source microcontroller version of the Python programming language [D. W. Hall. PyMite]. Though still in the preliminary stages, a dynamic interpreted language tailored to the needs of sensor networks will make programming and interfacing to sensor networks easier and more scalable. The first version of this framework, called Snarf (Sensor Network Application Retasking Framework) is targeted for the Plug platform.

Table 1 presents an embodiment of an example Python module for collecting and manipulating data obtained over USB from the Plug.

TABLE 1
import sys
import usb
import time
import struct
import array
import math
class DeviceDescriptor(object) :

def _{——}init_{——}(self, vendor_id, product_id, interface_id) :

self.vendor_id = vendor_id
self.product_id = product_id
self.interface_id = interface_id

def getDevice(self) :

“““
Return the device corresponding to the device descriptor if it

is

available on a USB bus. Otherwise, return None. Note that the
returned device has yet to be claimed or opened.
”””
buses = usb.busses( )
for bus in buses :

for device in bus.devices :

if device.idVendor == self.vendor_id :

if device.idProduct == self.product_id :

return device

return None

class PlugUSBDevice(object) :

PLUG_VENDOR_ID = 0x03EB
PLUG_PRODUCT_ID = 0x6124
PLUG_INTERFACE_ID = 0
PLUG_BULK_IN_EP = 2
PLUG_BULK_OUT_EP = 1
def _{——}init_{——}(self) :

self.device_descriptor =

DeviceDescriptor(PlugUSBDevice.PLUG_VENDOR_ID,
PlugUSBDevice.PLUG_PRODUCT_ID,
PlugUSBDevice.PLUG_INTERFACE_ID)

self.device = self.device_descriptor.getDevice( )
self.handle = None

def open(self) :

self.device = self.device_descriptor.getDevice( )
self.handle = self.device.open( )
if sys.platform == ‘darwin’ :

# XXX : For some reason, Mac OS X doesn't set the
# configuration automatically like Linux does.
self.handle.setConfiguration(1)

self.handle.claimInterface(self.device_descriptor.interface_id)

def close(self) :

self.handle.releaselnterface( )

def getDataPacket(self, bytesToGet) :

“““
Assume bytesToGet is two bytes wide.
”””
self.handle.bulkWrite(PlugUSBDevice.PLUG_BULK_OUT_EP,

chr(0)+chr(bytesToGet &

0xFF)+chr(bytesToGet>>8),

200)

# XXX : Gah! Returns a tuple of longs. Why doesn't it return
# a string?
return self.handle.bulkRead(PlugUSBDevice.PLUG_BULK_IN_EP,

bytesToGet,
200)

class PlugSensors(object) :

def _{——}init_{——}(self,

```
  bytesPerDataPacket=64,
  bitsPerSample=10,
  channelsPerScan=8,
  scansPerDataPacket=6) :
```

# Number of bytes the Plug returns in a sensors data packet.
self.bytesPerDataPacket = bytesPerDataPacket
# Resolution at which ADC samples inputs.
self.bitsPerSample = bitsPerSample
# Number of ADC channels sampled in a single pass.
self.channelsPerScan = channelsPerScan
# Number of times all ADC channels are sampled per packet.
self.scansPerDataPacket = scansPerDataPacket
# Needed to convert from signed longs to string.
self._{——}unpack_format_{——} = ‘B’*self.bytesPerDataPacket
# Needed to convert from string to unsigned bytes.
self._{——}pack_format_{——} = ‘b’*self.bytesPerDataPacket
# Information not generated by ADC.
self.numADCBytes =

self.bitsPerSample*self.channelsPerScan*self.scansPerDataPacket/8

self.skippedSamplesIndex =

self.bitsPerSample*self.channelsPerScan*self.scansPerDataPacket/8

self.bytesUsedIndex = self.skippedSamplesIndex + 1
self.vibrationIndex = self.skippedSamplesIndex + 2
assert self.bytesPerDataPacket*8 >=

self.bitsPerSample*self.channelsPerScan*self.scansPerDataPacket

self.plug = PlugUSBDevice( )
self.plug.open( )

def logSamplesToFile(self, filename) :

f = file(filename, ‘w’)
print “To stop data collection, type <CTRL> + c.”
startTime = time.time( )
f.write(“# Plug data log. Data format is:\n#\n”)
f.write(“# current time in seconds\n”)
f.write(“# scans recorded between the last time and the current

time\n”)

f.write(“# scans skipped between the last time and the current

time\n”)

f.write(“# light samples\n”)
f.write(“# sound samples\n”)
f.write(“# vibration samples\n”)
f.write(“# voltage samples\n”)
f.write(“# current1 samples\n”)
f.write(“# current2 samples\n”)
f.write(“# current3 samples\n”)
f.write(“# current4 samples\n”)
f.write(“# expansion samples\n”)
while True :

try :

data = self.getSamples( )
format_string = (“%d\t”*(data[‘scans_recorded’]−1) +

“%d\n”)

f.write(“\n%f\n” % data[‘time’])
f.write(“%d\n” % data[‘scans_recorded’])
f.write(“%d\n” % data[‘scans_skipped’])
f.write(format_string % tuple(data[‘light’]))
f.write(format_string % tuple(data[‘sound’]))
f.write(format_string % tuple(data[‘vibration’]))
f.write(format_string % tuple(data[‘voltage’]))
f.write(format_string % tuple(data[‘current1’]))
f.write(format_string % tuple(data[‘current2’]))
f.write(format_string % tuple(data[‘current3’]))
f.write(format_string % tuple(data[‘current4’]))
f.write(format_string % tuple(data[‘expansion’]))

except KeyboardInterrupt :

print “You have successfully logged data.”
f.close( )
return

def parseSamplesFromFile(self, filename) :

# Store sensor data in arrays of unsigned shorts (minimum of
# two bytes).
sensors = [array.array(‘H’),

array.array(‘H’),
array.array(‘H’),
array.array(‘H’),
array.array(‘H’),
array.array(‘H’),
array.array(‘H’),
array.array(‘H’),
array.array(‘H’)]

# Store time data in an array of floats (minimum of 8 bytes).
seconds = array.array(‘d’)
# Open the log file.
f = file(filename, ‘r’)
# Skip over the initial comments.
line = f.readline( )
while line != ‘’ and line[0] == “#” :

line = f.readline( )

line = f.readline( ) # Skip blank line.
while line ! = ‘’ :

time_recorded = float(line)
scans_recorded = int(f.readline( ))
scans_skipped = int(f.readline( ))
for i in range(scans_recorded) :

seconds.append(time_recorded)

for i in range(len(sensors)) :

for x in f.readline( ).split( ) :

sensors [i].append(int(x))

f.readline( ) # Skip blank line.
line = f.readline( )

return {“seconds” : seconds,

“light” : sensors[0],
“sound” : sensors[1],
“vibration” : sensors[2] ,
“voltage” : sensors[3] ,
“current1” : sensors[4],
“current2” : sensors[5],
“current3” : sensors[6],
“current4” : sensors[7],
“expansion” : sensors[8]}

def getSamples(self) :

samples = { }
# Request and wait for a packet.
packet = self.plug.getDataPacket(self.bytesPerDataPacket)
# Convert data from signed to unsigned.
data = struct.unpack(self._{——}unpack_format_{——},

struct.pack(self._{——}pack_format_{——}, *packet))

# Get all metadata.
samples[‘time’] = time.time( )
samples[‘scans_skipped’] = data[self.skippedSamplesIndex]
samples[‘scans_recorded’] =

data[self.bytesUsedIndex]*8/(self.bitsPerSample*self.channelsPerScan)

# Unpack the two bytes of vibratab data.
samples[‘vibration’] =

self.unpackBits(data[self.vibrationIndex:self.vibrationIndex+2],
1)[:samples[‘scans_recorded’]]

# Unpack ADC data.
data = self.unpackBits(data[:self.numADCBytes], 10)
# XXX : This next portion is hard coded.
samples[‘light’] = [data[i] for i in

range(0,samples[‘scans_recorded’]*self.channelsPerScan,self.channelsPer
Scan)]

samples[‘sound’] = [data[i] for i in

range(1,samples[‘scans_recorded’]*self.channelsPerScan,self.channelsPer
Scan)]

samples[‘voltage’] = [data[i] for i in

range(2,samples[‘scans_recorded’]*self.channelsPerScan,self.channelsPer
Scan)]

samples[‘expansion’] = [data[i] for i in

range(3,samples[‘scans_recorded’]*self.channelsPerScan,self.channelsPer
Scan)]

samples[‘current4’] = [data[i] for i in

range(4,samples[‘scans_recorded’]*self.channelsPerScan,self.channelsPer
Scan)]

samples[‘current2’] = [data[i] for i in

range(5,samples[‘scans_recorded’]*self.channelsPerScan,self.channelsPer
Scan)]

samples[‘current3’] = [data[i] for i in

range(6,samples[‘scans_recorded’]*self.channelsPerScan,self.channelsPer
Scan)]

samples[‘current1’] = [data[i] for i in

range(7,samples[‘scans_recorded’]*self.channelsPerScan,self.channelsPer
Scan)]

return samples

def unpackBits(self, s, bits) :

“““
Unpack a sequence s of bytes into a list of numbers each of

bits length.

Assumes numbers are stored in little endian format and

represent

unsigned integers.
”””
if (len(s)*8 < bits) :

return [ ]

bitMask = int(‘1’*bits, 2)
numberOfValues = int(8*len(s)/bits)
currentByte = 0
currentBit = 0
values = [ ]
while len(values) != numberOfValues :

bitsToGet = bits
if currentBit + bitsToGet < 8 :

value = (s[currentByte] >> currentBit) & bitMask
currentBit += bitsToGet
bitsToGet = 0

else :

value = (s[currentByte] >> currentBit)
bitsToGet −= (8 − currentBit)
currentBit = 0
currentByte += 1

for i in range(int(bitsToGet/8)) :

value |= (s[currentByte] << (bits − bitsToGet))
currentByte += 1
bitsToGet −= 8

if bitsToGet :

value |= ((s[currentByte] & int (‘1’*bitsToGet, 2)) <<

(bits − bitsToGet) )

currentBit = bitsToGet

values.append(value)

return values

def main(argv=None) :

if argv is None :

script_name = sys.argv[0]
argv = sys.argv[1:]

if len(argv) == 1 :

option = argv[0]
filename = “PlugSensors.dat”

elif len(argv) == 2 :

option = argv[0]
filename = argv[1]

else :

option = None
filename = None

if option == ‘log’ :

s = PlugSensors( )
s.logSamplesToFile(filename)
s.plug.close( )

elif option == ‘parse’ :

s = PlugSensors( )
return s.parseSamplesFromFile(filename)

elif option == ‘sensors’ :

s = PlugSensors( )
for i in range(10) :

print s.getSamples( )

else :

print “Usage: python −i %s OPTION [FILENAME]” % script_name
print “ where OPTION can be ‘parse’ or ‘log’”

if _{——}name_{——} == “_{——}main_{——}” :

data = main( )
if type(data) == dict :

print “Parsed data is now availabe in the ‘data’ dictionary.”
print “You can access the arrays of data looking at

\“data[‘light’]\”, for example.”

print “Use ‘data.keys( )’ to list other options,”

Table 3 is an embodiment of an example Python script for parsing a data set obtained from the Plug.

TABLE 3

# Arrays are better suited than lists to handle elements all of the
# same type.
import array
# Let's see how long it takes to parse all the data.
import time
start_time = time.time( )
# Read in the entire data file as a single string.
f = file(‘plug-halloween.dat’, ‘r’)
# Create an array for each of the sensors and the time in seconds at
# which the sensors were read.
seconds = array.array(‘d’)
light = array.array(‘B’)
microphone = array.array(‘B’)
voltage = array.array(‘B’)
expansion = array.array(‘B’)
current4 = array.array(‘B’)
current2 = array,array(‘B’)
current3 = array.array(‘B’)
current1 = array.array(‘B’)
vibratab = array.array(‘B’)
# Parse the data.
while True :

buf = [ ]
c = f.read(1)
if c == ‘’ :

break

while c ! = ‘\n’ :

buf.append(c)
c = f.read(1)

seconds.append(float(‘’.join(buf)))
light.append(ord(f.read(1)))
microphone.append(ord(f.read(1)))
voltage.append(ord(f.read(1)))
expansion.append(ord(f.read(1)))
current4.append(ord(f.read(1)))
current2.append(ord(f.read(1)))
current3.append(ord(f.read(1)))
current1.append(ord(f.read(1)))
vibratab.append(ord(f.read(1)))
assert f.read(1) == ‘\n’

f.close( )
end_time = time.time( )
print ”Elapsed time to parse data:”, end_time-start_time

The Plug is also able to monitor the dynamic current taken at each plug. This means that any item plugged into this device will have its power continually monitored, which is useful for energy saving applications. As the dynamic current is sampled, identification algorithms can be run on the current waveform, the AC voltage also being sampled, enabling different devices that are plugged into the Plug to be identified and additionally their mode of operation to be ascertained (e.g., a printer starting up or printing pages, etc.).

Aside from using the Plug platform as a basis for other projects, it will be clear to a person having ordinary skill in the art that modifications and improvements may be made to the platform itself. For example, the Plug platform communication capabilities may be improved, or the Plug platform may benefit from some hybrid of energy efficient and always-on MAC layers [W. Ye and J. Heidemann, “Medium access control in wireless sensor networks”, Technical Report ISI-TR-580, USC Information Sciences Institute, October 2003]. Such an approach would more closely mirror the heterogeneous nature of the platform, with small battery-powered devices roaming among a fixed powered network of Plugs. Incorporating an IEEE 802.11 (WiFi) radio into the Plug is a possibility, and the robustness of the network, a necessity for long-term deployment, would also benefit from a more agile channel sharing and link determination algorithm.

In one embodiment, the platform is improved by the addition of some form of power line communication to integrate the Plugs even more tightly with their deployment environment [M. Gotz, M. Rapp, and K. Dostert. Power line channel characteristics and their effect on communication system design. IEEE Communications Magazine, 42(4):78-86, April 2004; M. Lobashov, G. Pratl, and T. Sauter. Implications of power-line communication on distributed data acquisition and control systems. In Proceedings of ETFA '03 (Emerging Technologies and Factory Automation), volume 2, pages 607-613, September 2003; N. Pavlidou, A. H. Vinck, J. Yazdani, and B. Honary. Power line communications: state of the art and future trends. IEEE Communications Magazine, 41(4):34-40, April 2003]. Even low-bandwidth power line communication provides a valuable side channel for network discovery, network maintenance, and even sensing, permitting certain electrical failures to be detected and isolated by network means alone. Just as network connectivity in a wireless network reveals information about the surrounding environment, such as rough localization, so does the network connectivity in a wired power line network. Any power line communication should preferably be tolerant of highly variable line noise and it may be necessary to rely on another communication channel, such as wireless, to bridge between different electrical phases or feeds, as are common in large buildings. Between standard WiFi and power line communication, the main reason for the Plugs to have the lightweight CC2500 radio is to communicate with power constrained sensor nodes that have no other means of communicating. Nonetheless, this is a compelling reason given the centrality of mobile sensor nodes in the current vision of ubiquitous computing.

The present invention enables a host of applications. Such a dense sensor network deployed across inhabited spaces collects a very rich sample of data that can be used to determine context—e.g., determine what kind of things people are doing at any given point, often selected from a finite subset of possibilities, in order that applications can be best run or tailored, actions taken, or information provided that is appropriate at any given time). Energy and operation of devices that are plugged into the plugs can be dynamically monitored for conservation or diagnostic purposes. Browsers that fuse the information from multiple plugs can enable a virtual visit to the site where the plugs are deployed. Audio or perhaps even images from different plugs can be dynamically mixed or played on a browser station as a user moves virtually between plugs, allowing users of the PLUG system to extend their awareness into the Plug network.

In one application that has been implemented, a “tricorder” pulls sensor data off the surrounding Plug sensor network. This application is aware of its absolute orientation though use of a high-end 3-axis compass. This, combined with coarse RSSI-based localization from the Plugs, allows for real-time point-and-browse functionality from within the sensor network itself Specifically, the orientation information is used to maintain the displayed map of the lab at a fixed orientation relative to the actual lab and the map re-centers itself according to the RS SI information gathered from nearby Plugs, whose locations are assumed to be known. A working first prototype of the tricorder uses a battery-powered Lug to interface to a Nokia 770 web tablet via USB, to an off-the-shelf PNI TCM3 compass module via USART, and to the Plug sensor network via a 2.4 GHz ChipCon CC2500 radio. The tricorder user interface consists of a floor plan of the lab overlaid with Plug icons depicting sound (concentric blue circles), light (radial red lines), RSSI (green central circle), current consumption (black central dial), and motion (orange ring around the green circle). The icons jitter slightly to represent vibration. An auxiliary side panel shows bar graphs of the average and extrema data for all sensor modalities from a single Plug. The exact Plug shown in detail is either selected automatically according to the strongest radio signal or manually via the touch screen.

The Plug system can also be used as a distributed output device. For example, audio can be generated or played by Plugs at different locations with different amplitudes, enabling, for example, a dynamic audio screen, where the appropriate amount of audio is faded up at the appropriate locations to best mask conversations that are happening from other nearby people. The Plug can detect people nearby, know when conversations are happening by direct notice (e.g., pushing a button) or via the Plug sensors, and know the location of people (by PIR motion sensors, IR or RF emitted by worn badges or Lugs that are contained in the system, etc), and fade up the appropriate masking audio at the appropriate location. Other distributed audio applications are possible with the Plug network.

As nearby Plugs can sense stimuli created by other Plugs or sense events that are detected in common from external stimuli, they are able to calibrate each other, and determine parameters such as relative location. For example, common detection of changes in light indicate that they are in the same room, common vibration indicates that they are on the same table, floor, or surface, and differences in the timing of common audio events can be processed to detect their relative location. Differences in the amplitude or timing of radio signals arriving at Plugs and generated by other Plugs or Lugs can also be processed to determine location of the Plugs or Lugs.

The Plug sensor network is a viable platform for collecting data in the home or office environment. In doing so, each Plug can not only monitor its environment, but it can also play an active and useful role therein, thus making the data collected richer and more meaningful than could be hoped for with a more detached system. Without the need to conserve battery life, Plugs are free to continuously monitor their environment and perform such calculations collaboratively within the network rather than offline. Per the founding concept of ubiquitous computing, the Plug sensor network can disappear into its environment by virtue of its utility.

While a preferred embodiment is disclosed, many other implementations will occur to one of ordinary skill in the art and are all within the scope of the invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Other arrangements, methods, modifications, and substitutions by one of ordinary skill in the art are therefore also considered to be within the scope of the present invention.

1. A sensor platform, comprising:
a power outlet apparatus, the power outlet apparatus containing at least one power distribution socket;
at least one environmental sensor integrated into the power outlet apparatus; and
at least one transceiver, the transceiver for communicating data measured by the sensor to a remote receiving unit.

2. The sensor platform of claim 1, wherein the power outlet apparatus is a power strip.

3. The sensor platform of claim 1, wherein the power outlet apparatus is configured to plug into a power distribution socket.

4. The sensor platform of claim 1, further comprising a controller for directing measurement and communication of data by the sensor.

5. The sensor platform of claim 1, wherein the at least one sensor is selected from the group consisting of a light sensor, a motion detector, a vibration detector, a temperature sensor, and a microphone.

6. The sensor platform of claim 1, wherein the transceiver communicates using wireless communication.

7. The sensor platform of claim 1, wherein the transceiver communicates using a wired communications link.

8. The sensor platform of claim 1, further comprising an expansion port capable of accepting at least one additional sensor.

9. The sensor platform of claim 1, further comprising a memory device for logging data measured by at least one sensor.

10. The sensor platform of claim 1, further comprising at least one current or voltage monitor.

11. The sensor platform of claim 1, further comprising a speaker.

12. A sensor network, comprising:
a plurality of sensor platforms, each sensor platform comprising:
a power outlet apparatus, the power outlet apparatus containing at least one power distribution socket;
at least one environmental sensor integrated into the power outlet apparatus; and
at least one transceiver, the transceiver for communicating data measured by the sensor to a remote receiving unit; and
at least one controller for receiving and relating data received from the plurality of sensor platforms.

13. The sensor network of claim 12 wherein, in at least some of the sensor platforms, the power outlet apparatus is a power strip.

14. The sensor network of claim 12 wherein, in at least some of the sensor platforms further comprise a controller for directing measurement and communication of data by the sensor.

15. The sensor network of claim 12, wherein the at least one sensor is selected from the group consisting of a light sensor, a motion detector, a vibration detector, and a microphone.

16. The sensor network of claim 12, wherein at least one of the transceivers communicates using wireless communication.

17. The sensor network of claim 12, wherein at least one of the transceivers communicates using a wired communications link.
